(19) United States
(12) Patent Application Publication
(10) Pub. No.: US 2012/0287111 A1
(43) Pub. Date: Nov. 15, 2012

(54) PLASMA DISPLAY DEVICE AND PLASMA DISPLAY PANEL DRIVING METHOD

(76) Inventors: Jun Kamiyamaguchi, Osaka (JP); Takahiko Origuchi, Osaka (JP); Masahiro Yamada, Osaka (JP)

(21) Appl. No.: 13/519,260

(22) PCT Filed: Jan. 12, 2011
(86) PCT No.: PCT/JP2011/000082

§ 371 Date: Jun. 26, 2012

(30) Foreign Application Priority Data
Jan. 12, 2010 (JP) 2010-003747

(51) Int. Cl. G09G 3/28; G09G 5/00

(52) U.S. Cl. 345/212; 345/60

(57) ABSTRACT

Image display quality of a plasma display apparatus is enhanced. For this purpose, the plasma display apparatus includes a number-of-sustain-pulses corrector for controlling the number of sustain pulses to be generated. The number-of-sustain-pulses corrector includes an all-cell light-emitting rate detection circuit (46), a partial light-emitting rate detection circuit (47), and a lookup table. The number-of-sustain-pulses corrector sets a correction coefficient that is read out from the lookup table in response to an all-cell light-emitting rate and a partial light-emitting rate as a first correction coefficient, and a recorrection coefficient that is based on the first correction coefficient. The number-of-sustain-pulses corrector adjusts the first correction coefficient and the recorrection coefficient, using an adjustment gain preset for each subfield in response to the magnitude of the luminance weight. The number-of-sustain-pulses corrector corrects the number of sustain pulses, using the first correction coefficient and the recorrection coefficient adjusted with the adjustment gain.

### TECHNICAL FIELD

The present invention relates to a plasma display apparatus and a driving method for a plasma display panel that are used for a wall-mounted television or a large monitor.

### BACKGROUND ART

A typical AC surface discharge panel used as a plasma display panel (hereinafter simply referred to as “panel”) has a large number of discharge cells that are formed between a front substrate and a rear substrate facing each other. With the front substrate, a plurality of display electrode pairs, each formed of a scan electrode and a sustain electrode, is disposed on a front glass substrate parallel to each other. A dielectric layer and a protective layer are formed so as to cover the display electrode pairs.

With the rear substrate, a plurality of parallel data electrodes is formed on a rear glass substrate, and a dielectric layer is formed so as to cover the data electrodes. Further, a plurality of barrier ribs is formed on the dielectric layer parallel to the data electrodes. Phosphor layers are formed on the surface of the dielectric layer and on the side faces of the barrier ribs.

The front substrate and the rear substrate are opposed to each other and sealed together such that the display electrode pairs three-dimensionally intersect the data electrodes. The sealed inside discharge space is filled with a discharge gas containing xenon in a partial pressure ratio of 5%, for example. Discharge cells are formed in portions where the display electrode pairs face the data electrodes. In the thus structured panel, a gas discharge generates ultraviolet rays in the respective discharge cells. These ultraviolet rays excite the red (R), green (G), and blue (B) phosphors such that the phosphors of the respective colors emit light for color image display.

A typically used method for driving the panel is a subfield method. In the subfield method, one field is divided into a plurality of subfields, and gradations are displayed by causing light emission or no light emission in each discharge cell in each subfield. Each subfield has an initializing period, an address period, and a sustain period.

In the initializing periods, an initializing waveform is applied to the respective scan electrodes so as to cause an initializing discharge in the respective discharge cells. This initializing discharge forms wall charge necessary for the subsequent address operation in the respective discharge cells and generates priming particles (excitation particles for causing an address discharge) for causing a stable address discharge.

In the address periods, a scan pulse is sequentially applied to the scan electrodes (hereinafter this operation being also referred to as “scanning”). Further, an address pulse in response to a signal of an image to be displayed is applied selectively to the data electrodes. Thus, an address discharge is caused between the scan electrodes and the data electrodes so as to form wall charge in the discharge cells to be lit (hereinafter these operations being also generically referred to as “addressing”).

In each sustain period, a number of sustain pulses predetermined for the subfield are applied alternately to display electrode pairs, each formed of a scan electrode and a sustain electrode. This operation causes a sustain discharge in the discharge cells having undergone the address discharge, thus causing the phosphor layers of the discharge cells to emit light. (Hereinafter, causing a discharge cell to be lit by a sustain discharge is also referred to as “lighting”, and causing a discharge cell not to be lit as “non-lighting”). Thereby, the respective discharge cells are lit at luminances corresponding to the luminance weight predetermined for each subfield. In this manner, the respective discharge cells of the panel are lit at the luminances corresponding to the gradation values of the image signals. Thus, an image is displayed on the image display surface of the panel.

The subfield methods include the following driving method in which operations are performed as follows. In the initializing period of one subfield among a plurality of subfields, an all-cell initializing operation for causing an initializing discharge in all the discharge cells is performed. In the initializing periods of the other subfields, a selective initializing operation for causing an initializing discharge only in the discharge cells having undergone a sustain discharge in the immediately preceding sustain periods is performed. With these operations, the luminance of a region displaying black where no sustain discharge occurs (hereinafter “luminance of black level”) is determined by the weak light emission in the all-cell initializing operation. This can minimize the light emission unrelated to gradation display and thus enhance the contrast ratio of the display image.

A difference in drive load (impedance when a driver circuit applies a driving voltage to electrodes) between display electrode pairs causes a difference in the voltage drop in the driving voltage. This can cause a difference in emission luminance between the discharge cells even when image signals have an equal luminance. In order to address this problem, the following technique is disclosed (see Patent Literature 1, for example). With this technique, the lighting pattern of the subfields in one field is changed when the drive load varies between the display electrode pairs.

With a recent increase in the screen size and the definition of the panel, the drive load of the panel tends to increase. In such a panel, the difference in drive load between the display electrode pairs, and thus the difference in the voltage drop in the driving voltage are likely to increase.

A difference in drive load between subfields causes a difference in the emission luminance in one sustain discharge between the subfields. When a panel is driven by a subfield method, as described above, gradations are displayed by dividing one field period into a plurality of subfields and combining the lighting subfields. Thus, the difference in the emission luminance in one sustain discharge between the subfields can impair the linearity of gradations.

In a panel having a drive load increased by the larger screen size and higher definition, a difference in drive load between subfields tends to increase. This increases the difference in emission luminance between subfields, which tends to impair the linearity of gradations. In order to display an image with the linearity of gradations maintained in such a panel, it is preferable to control the luminance of each subfield optimally for the difference in the emission luminance in each subfield.

Further, in the large, high-definition panel of a plasma display apparatus, enhancing the image display quality is in demand. The brightness of an image displayed on the panel is one of factors in determining the image display quality. Therefore, it is preferable to minimize a change in the brightness in the display image when a correction is made so as to change the lighting pattern of subfields, for example.

### CITATION LIST

### Patent Literature

PTL1
Japanese Patent Unexamined Publication No. 2006-184843

### SUMMARY OF THE INVENTION

A plasma display apparatus of the present invention includes the following elements:

a panel having a plurality of discharge cells where a plurality of subfields having a luminance weight is disposed in one field and as many sustain pulses as a number corresponding to the luminance weight are applied in the sustain period of each subfield to emit light;

an image signal processing circuit for converting an input image signal into image data representing light emission and no light emission in each discharge cell in each subfield;

a sustain pulse generation circuit for generating the sustain pulses corresponding in number to the luminance weight and applying the sustain pulses to the discharge cells in the sustain period;

an all-cell light-emitting rate detection circuit for detecting a rate of the number of discharge cells to be lit with respect to the number of all discharge cells on an image display surface of the panel, as an all-cell light-emitting rate in each subfield;

a partial light-emitting rate detection circuit for dividing the image display surface of the panel into a plurality of regions and detecting a rate of the number of discharge cells to be lit with respect to the number of discharge cells in each of the regions, as a partial light-emitting rate in each subfield; and

a timing generation circuit that generates timing signals for controlling the sustain pulse generation circuit, and includes a number-of-sustain-pulses corrector for controlling the number of sustain pulses to be generated in the sustain pulse generation circuit.

The number-of-sustain-pulses corrector includes a lookup table that has stored a plurality of correction coefficients correlated with the all-cell light-emitting rates and the partial light-emitting rates. In each subfield, the number-of-sustain-pulses corrector adjusts a first correction coefficient that is read out from the lookup table based on the all-cell light-emitting rate and the partial light-emitting rate and is set for each subfield, and a recorrection coefficient that is set based on the first correction coefficient, by using an adjustment gain having been preset for each subfield in response to the magnitude of the luminance weight. The number-of-sustain-pulses corrector corrects the number of sustain pulses set for each subfield based on the input image signal and the luminance weight, by using the first correction coefficient and the recorrection coefficient that have been adjusted with the adjustment gain.

With this configuration, the first correction coefficient set based on the all-cell light-emitting rate and the partial light-emitting rate, and the recorrection coefficient set based on the first correction coefficient can be adjusted, using the adjustment gain set for each subfield in response to the magnitude of the luminance weight. The number of sustain pulses can be corrected, using the adjusted first correction coefficient and the adjusted recorrection coefficient. Thus, even in a large, high-definition panel, the linearity of gradations in the display image and the brightness of the display image can be controlled. Thereby, the image display quality in the plasma display apparatus can be enhanced.

In the plasma display apparatus, the adjustment gain may be set to 0% in the subfields set as those having light luminance weights, and set to 100% in the subfields set as those having heavy luminance weights. The adjustment gain may be set to a magnitude in response to the magnitude of the luminance weight in each of the subfields between the subfields having light luminance weights and the subfields having heavy luminance weights.

In the plasma display apparatus, the number-of-sustain-pulses corrector may set a second correction coefficient as the recorrection coefficient, and set the second correction coefficient such that a total numbers of sustain pulses in one field period can be equivalent to each other before a correction and after the correction corrected with the first correction coefficient and the second correction coefficient.

In the plasma display apparatus, the number-of-sustain-pulses corrector may set a third correction coefficient as the recorrection coefficient, and set the third correction coefficient such that the estimated values of electric power consumption in one field period can be equivalent to each other before a correction and after the correction corrected with the first correction coefficient and the third correction coefficient.

The plasma display apparatus may include an APL (Average Picture Level) detection circuit for detecting an average picture level of the display image, and the number-of-sustain-pulses corrector may set a fourth correction coefficient, which is obtained by mixing the second correction coefficient and the third correction coefficient at a rate in response to the detection result in the APL detection circuit, as the recorrection coefficient. Further, the number-of-sustain-pulses corrector may set the second correction coefficient such that the total numbers of sustain pulses in one field period can be equivalent to each other before a correction and after the correction corrected with the first correction coefficient and the second correction coefficient. The number-of-sustain-pulses corrector may set the third correction coefficient such that the estimated values of electric power consumption in one field period can be equivalent to each other before a correction and after the correction corrected with the first correction coefficient and the third correction coefficient.

In the plasma display apparatus, the partial light-emitting rate detection circuit may calculate an average value of the partial light-emitting rates in the regions where the partial light-emitting rates exceed a predetermined threshold in each subfield. The first correction coefficient may be read out from the lookup table based on the all-cell light-emitting rate and the average value of the partial light-emitting rates.

In the plasma display apparatus, the partial light-emitting rate detection circuit may define one display electrode pair as the one region and detect the partial light-emitting rate for each display electrode pair.

In a driving method for a panel of the present invention, the panel emits light in discharge cells by disposing a plurality of subfields, each of which has a luminance weight in one field and applying as many sustain pulses as the number corresponding to the luminance weight to the discharge cells in the sustain period. A rate of the number of discharge cells to be lit with respect to the number of all discharge cells on an image display surface of the panel is detected as an all-cell light-emitting rate, in each subfield. The image display surface of the panel is divided into a plurality of regions, and a rate of the number of discharge cells to be lit with respect to the number of discharge cells in each of the regions is detected as a partial light-emitting rate, in each subfield. In each subfield, a first correction coefficient based on the all-cell light-emitting rate and the partial light-emitting rate is set, and a recorrection coefficient based on the first correction coefficient is set. By using an adjustment gain having been preset for each subfield in response to the magnitude of the luminance weight, the first correction coefficient and the recorrection coefficient are adjusted. The number of sustain pulses set for each subfield based on an input image signal and the luminance weight is corrected, by using the first correction coefficient and the recorrection coefficient that have been adjusted with the adjustment gain.

With this operation, the first correction coefficient set based on the all-cell light-emitting rate and the partial light-emitting rate, and the recorrection coefficient set based on the first correction coefficient can be adjusted, using the adjustment gain set for each subfield in response to the magnitude of the luminance weight. The number of sustain pulses can be corrected, using the adjusted first correction coefficient and the adjusted recorrection coefficient. Thus, even in a large, high-definition panel, the linearity of gradations in the display image and the brightness of the display image can be controlled. Thereby, the image display quality in the plasma display apparatus can be enhanced.

### BRIEF DESCRIPTION OF DRAWINGS

FIG. 1 is an exploded perspective view showing a structure of a panel in accordance with a first exemplary embodiment of the present invention.

FIG. 2 is an electrode array diagram of the panel in accordance with the first exemplary embodiment.

FIG. 3 is a chart of driving voltage waveforms applied to the respective electrodes of the panel in accordance with the first exemplary embodiment.

FIG. 4 is a circuit block diagram of a plasma display apparatus in accordance with the first exemplary embodiment.

FIG. 5 is a circuit diagram showing a configuration of a scan electrode driver circuit of the plasma display apparatus in accordance with the first exemplary embodiment.

FIG. 6 is a circuit diagram showing a configuration of a sustain electrode driver circuit of the plasma display apparatus in accordance with the first exemplary embodiment.

FIG. 7A is a schematic diagram for explaining a difference in the emission luminance caused by a change in drive load.

FIG. 7B is a schematic diagram for explaining the difference in the emission luminance caused by a change in drive load.

FIG. 8A is a schematic diagram for explaining another example of a difference in the emission luminance caused by a change in drive load.

FIG. 8B is a schematic diagram for explaining the example of the difference in the emission luminance caused by a change in drive load.

FIG. 9 is a diagram schematically showing measurement of emission luminance performed in order to set a correction coefficient in accordance with the first exemplary embodiment of the present invention.

FIG. 10 is a table showing examples of correction coefficients in accordance with the first exemplary embodiment.

FIG. 11 is a circuit block diagram of a number-of-sustain-pulses corrector in accordance with the first exemplary embodiment.

FIG. 12 is a diagram showing a part of the circuit blocks of a timing generation circuit in accordance with a second exemplary embodiment of the present invention.

FIG. 13 is a table for explaining “second correction” using specific numerical values in accordance with the second exemplary embodiment.

FIG. 14 is a diagram showing a part of the circuit blocks of a timing generation circuit in accordance with a third exemplary embodiment of the present invention.

FIG. 15 is a table for explaining “third correction” using specific numerical values in accordance with the third exemplary embodiment.

FIG. 16 is a circuit block diagram of a plasma display apparatus in accordance with a fourth exemplary embodiment of the present invention.

FIG. 17 is a diagram showing a part of the circuit blocks of a timing generation circuit in accordance with the fourth exemplary embodiment.

FIG. 18 is a graph showing an example of setting of variable k in accordance with the fourth exemplary embodiment.

FIG. 19 is a table for comparing the number of sustain pulses before “first correction” with the number of sustain pulses after “second correction” in accordance with an exemplary embodiment of the present invention.

FIG. 20 is a graph showing an increasing rate of the number of sustain pulses after “correction” with respect to that before “correction” in each subfield in accordance with the exemplary embodiment.

FIG. 21 is a table showing an example of the setting of adjustment gains in accordance with the fifth exemplary embodiment of the present invention.

### DESCRIPTION OF EMBODIMENTS

Hereinafter, a description is provided for a plasma display apparatus in accordance with the exemplary embodiments of the present invention with reference to the accompanying drawings.

### First Exemplary Embodiment

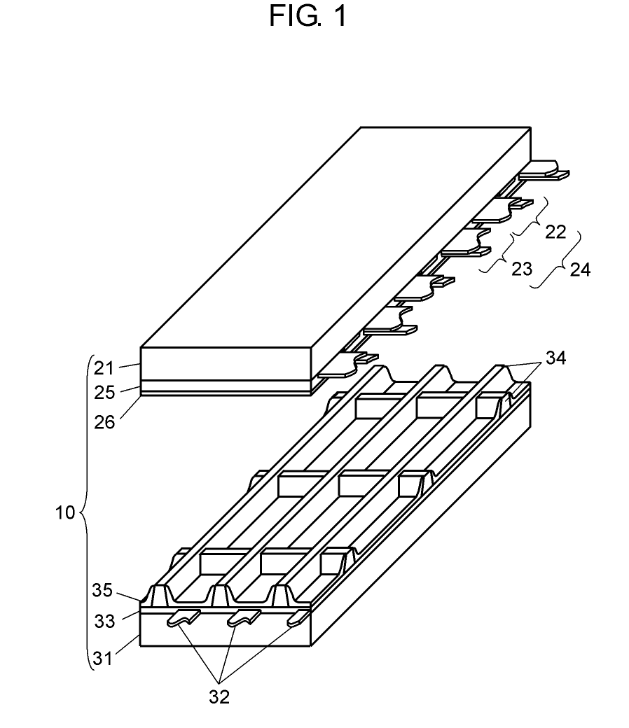

FIG. 1 is an exploded perspective view showing a structure of panel 10 in accordance with the first exemplary embodiment of the present invention. A plurality of display electrode pairs 24, each formed of scan electrode 22 and sustain electrode 23, is formed on glass front substrate 21. Dielectric layer 25 is formed so as to cover scan electrodes 22 and sustain electrodes 23. Protective layer 26 is formed over dielectric layer 25. Protective layer 26 is made of a material predominantly composed of magnesium oxide (MgO).

A plurality of data electrodes 32 is formed on rear substrate 31. Dielectric layer 33 is formed so as to cover data electrodes 32, and mesh barrier ribs 34 are formed on the dielectric layer. On the side faces of barrier ribs 34 and on dielectric layer 33, phosphor layers 35 each for emitting red (R) light, green (G) light, or blue (B) light are disposed.

Front substrate 21 and rear substrate 31 face each other such that display electrode pairs 24 intersect data electrodes 32 with a small discharge space sandwiched between the electrodes. The outer peripheries of the substrates are sealed with a sealing material, such as a glass frit. In the inside discharge space, a neon-xenon mixture gas, for example, is sealed as a discharge gas. In this exemplary embodiment, in order to enhance the emission efficiency, a discharge gas having a xenon partial pressure of approximately 10% is used.

The discharge space is partitioned into a plurality of compartments by barrier ribs 34. Discharge cells are formed in the intersecting parts of display electrode pairs 24 and data electrodes 32. Discharge and light emission (lighting) of these discharge cells allow display of a color image on panel 10.

In panel 10, three consecutive discharge cells arranged in the extending direction of display electrode pair 24, i.e. a discharge cell for emitting red (R) light, a discharge cell for emitting green (G) light, and a discharge cell for emitting blue (B) light, form one pixel. Hereinafter, a discharge cell for emitting red light is referred to as an R discharge cell, a discharge cell for emitting green light as a G discharge cell, and a discharge cell for emitting blue light as a B discharge cell.

The structure of panel 10 is not limited to the above. The panel may include barrier ribs in a stripe pattern, for example. The mixture ratio of the discharge gas is not limited to the above numerical value, and other mixture ratios may be used.

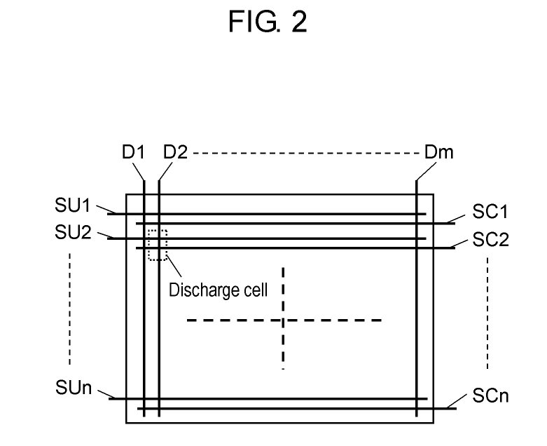

FIG. 2 is an electrode array diagram of panel 10 in accordance with the first exemplary embodiment of the present invention. Panel 10 has n scan electrode SC1-scan electrode SCn (scan electrodes 22 in FIG. 1) and n sustain electrode SU1-sustain electrode SUn (sustain electrodes 23 in FIG. 1) long in the line direction, and m data electrode D1-data electrode Dm (data electrodes 32 in FIG. 1) long in the column direction. A discharge cell is formed in the part where a pair of scan electrode SCi (i=1−n) and sustain electrode SUi intersects one data electrode Dj (j=1−m). That is, one display electrode pair 24 has m discharge cells, which form m/3 pixels. Then, m×n discharge cells are formed in the discharge space, and the area having m×n discharge cells is the image display surface of panel 10. For example, in a panel having 1920×1080 pixels, m=1920×3 and n=1080.

Next, driving voltage waveforms for driving panel 10 and the operation thereof are outlined. The plasma display apparatus of this exemplary embodiment displays gradations by a subfield method. In the subfield method, one field is divided into a plurality of subfields along a temporal axis, and a luminance weight is set for each subfield. By controlling light emission and no light emission in each discharge cell in each subfield, an image is displayed on panel 10.

The luminance weight represents a ratio of the magnitude of luminance displayed in each subfield. In the sustain period of each subfield, sustain pulses corresponding in number to the luminance weight are generated. For example, the number of sustain pulses to be generated in the subfield having the luminance weight “8” is eight times as large as that in the subfield having the luminance weight “1”, and is four times as large as that in the subfield having the luminance weight “2”. That is, the luminance of the light emission in the subfield having the luminance weight “8” is approximately eight times as high as that in the subfield having the luminance weight “1”, and is approximately four times as high as that in the subfield having the luminance weight “2”. Thus, by selectively causing light emission in the respective subfields in combination in response to image signals, various gradations and an image can be displayed.

In the example described in this exemplary embodiment, one field is formed of eight subfields (the first SF, the second SF, . . . , the eighth SF), and the respective subfields have luminance weights of 1, 2, 4, 8, 16, 32, 64, and 128 such that the temporally later subfields have the heavier luminance weights. In this structure, each of the R signal, the G signal, and the B signal can be displayed with 256 gradations of 0 through 255.

In the initializing period of one subfield among the plurality of subfields, an all-cell initializing operation for causing an initializing discharge in all the discharge cells is performed. In the initializing periods of the other subfields, a selective initializing operation for causing an initializing discharge selectively in the discharge cells having undergone a sustain discharge in the sustain periods of the immediately preceding subfields is performed. These operations can minimize the light emission unrelated to gradation display, reduce the emission luminance in a region displaying black where no sustain discharge occurs, and enhance the contrast ratio of an image displayed on panel 10. Hereinafter, a subfield where an all-cell initializing operation is performed is referred to as “all-cell initializing subfield”, and a subfield where a selective initializing operation is performed is referred to as “selective initializing subfield”.

In the example described in this exemplary embodiment, the all-cell initializing operation is performed in the initializing period of the first SF, and the selective initializing operation is performed in the initializing periods of the second SF through the eighth SF. With these operations, the light emission unrelated to image display is only the light emission caused by the discharge in the all-cell initializing operation in the first SF. Thus, the luminance of black level, i.e. the luminance in a region displaying black where no sustain discharge occurs, is determined only by the weak light emission in the all-cell initializing operation. Thereby, an image of high contrast can be displayed on panel 10.

In the sustain period of each subfield, sustain pulses equal in number to the luminance weight of the subfield multiplied by a predetermined proportionality factor are applied to respective display electrode pairs 24. This proportionality factor is a luminance magnification.

In this exemplary embodiment, when the luminance magnification is 1, in the sustain period of a subfield having the luminance weight “2”, four sustain pulses are generated and two sustain pulses are applied to each of scan electrodes 22 and sustain electrodes 23. That is, in each sustain period, sustain pulses equal in number to the luminance weight of the subfield multiplied by a predetermined luminance magnification are applied to each of scan electrodes 22 and sustain electrodes 23. Therefore, when the luminance magnification is 2, the number of sustain pulses to be generated in the sustain period of a subfield having the luminance weight “2” is 8. When the luminance magnification is 3, the number of sustain pulses to be generated in the sustain period of a subfield having the luminance weight “2” is 12.

However, in this exemplary embodiment, the number of subfields forming one field, and the luminance weight of each subfield are not limited to the above values. The subfield structure may be switched in response to an image signal, for example.

In this exemplary embodiment, the number of sustain pulses is changed in response to a light-emitting rate (a rate of the number of discharge cells to be lit with respect to a predetermined number of discharge cells) in each subfield, which is detected in all-cell light-emitting rate detection circuit 46 and partial light-emitting rate detection circuit 47 to be described later. This operation maintains the linearity of gradations in the image displayed on panel 10 and enhances the image display quality. Hereinafter, first, a description is provided for the outline of driving voltage waveforms and a configuration of a driver circuit. Next, a description is provided for a structure of controlling the number of sustain pulses in response to the light-emitting rates.

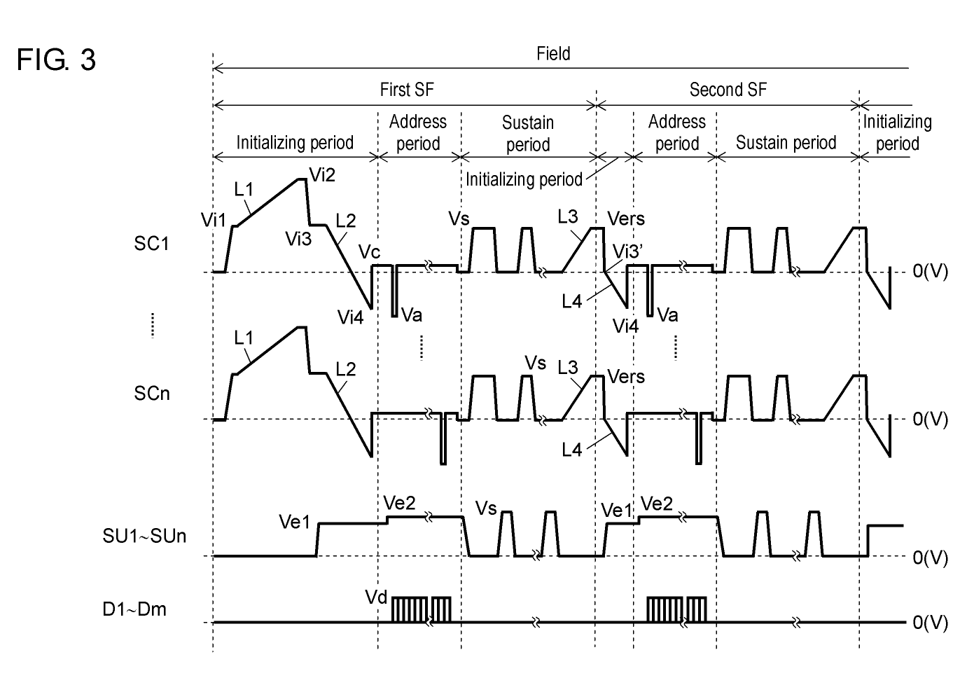

FIG. 3 is a chart of driving voltage waveforms applied to the respective electrodes of panel 10 in accordance with the first exemplary embodiment of the present invention. FIG. 3 shows driving voltage waveforms applied to the following electrodes: scan electrode SC1 to undergo an address operation first in the address periods; scan electrode SCn to undergo an address operation last in the address periods; sustain electrode SU1-sustain electrode SUn; and data electrode D1-data electrode Dm.

FIG. 3 shows driving voltage waveforms in two subfields: the first subfield (first SF), i.e. an all-cell initializing subfield; and the second subfield (second SF), i.e. a selective initializing subfield. The driving voltage waveforms in the other subfields are substantially the same as the driving voltage waveforms in the second SF except for the number of sustain pulses generated in the sustain period. Scan electrode SCi, sustain electrode SUi, and data electrode Dk in the following description show the electrodes selected among the corresponding electrodes in response to image data (data representing lighting and non-lighting in each subfield).

First, a description is provided for the first SF, an all-cell initializing subfield.

In the first half of the initializing period of the first SF, 0 (V) is applied to each of data electrode D1-data electrode Dm and sustain electrode SU1-sustain electrode SUn. Voltage Vi1 is applied to scan electrode SC1-scan electrode SCn. Voltage Vi1 is set to a voltage lower than a discharge start voltage with respect to sustain electrode SU1-sustain electrode SUn. Further, scan electrode SC1-scan electrode SCn are applied with a ramp waveform voltage that gently rises from voltage Vi1 toward voltage Vi2. Hereinafter, this ramp waveform voltage is referred to as “up-ramp voltage L1”. Voltage Vi2 is set to a voltage exceeding the discharge start voltage with respect to sustain electrode SU1-sustain electrode SUn. Examples of the gradient of this up-ramp voltage L1 include a numerical value of approximately 1.3 V/ηsec.

While up-ramp voltage L1 is rising, a weak initializing discharge continuously occurs between scan electrode SC1-scan electrode SCn and sustain electrode SU1-sustain electrode SUn, and between scan electrode SC1-scan electrode SCn and data electrode D1-data electrode Dm. Then, negative wall voltage accumulates on scan electrode SC1-scan electrode SCn; positive wall voltage accumulates on data electrode D1-data electrode Dm and sustain electrode SU1-sustain electrode SUn. Here, this wall voltage on the electrodes means the voltage generated by the wall charge that is accumulated on the dielectric layers covering the electrodes, the protective layer, the phosphor layers, or the like.

In the second half of the initializing period, positive voltage Ve1 is applied to sustain electrode SU1-sustain electrode SUn, and 0 (V) is applied to data electrode D1-data electrode Dm. Scan electrode SC1-scan electrode SCn are applied with a ramp waveform voltage that gently falls from voltage Vi3 toward negative voltage Vi4. Hereinafter, this ramp waveform voltage is referred to as “down-ramp voltage L2”. Voltage Vi3 is set to a voltage lower than the discharge start voltage with respect to sustain electrode SU1-sustain electrode SUn. Voltage Vi4 is set to a voltage exceeding the discharge start voltage. Examples of the gradient of this down-ramp voltage L2 include a numerical value of approximately −2.5 V/μsec.

While down-ramp voltage L2 is applied to scan electrode SC1-scan electrode SCn, a weak initializing discharge occurs between scan electrode SC1-scan electrode SCn and sustain electrode SU1-sustain electrode SUn, and between scan electrode SC1-scan electrode SCn and data electrode D1-data electrode Dm. This weak discharge reduces the negative wall voltage on scan electrode SC1-scan electrode SCn, and the positive wall voltage on sustain electrode SU1-sustain electrode SUn, and adjusts the positive wall voltage on data electrode D1-data electrode Dm to a value appropriate for the address operation. In this manner, the all-cell initializing operation for causing an initializing discharge in all the discharge cells is completed.

In the subsequent address period, a scan pulse at voltage Va is applied sequentially to scan electrode SC1-scan electrode SCn. An address pulse at positive voltage Vd is applied to data electrode Dk corresponding to a discharge cell to be lit among data electrode D1-data electrode Dm. Thus, an address discharge is caused selectively in the corresponding discharge cells.

Specifically, voltage Ve2 is applied to sustain electrode SU1-sustain electrode SUn, and voltage Vc is applied to scan electrode SC1-scan electrode SCn.

Next, a scan pulse at negative voltage Va is applied to scan electrode SC1 in the first line, and an address pulse at positive voltage Vd is applied to data electrode Dk of the discharge cell to be lit in the first line among data electrode D1-data electrode Dm. At this time, the voltage difference in the intersecting part of data electrode Dk and scan electrode SC1 is obtained by adding the difference between the wall voltage on data electrode Dk and the wall voltage on scan electrode SC1 to a difference in externally applied voltage (voltage Vd-voltage Va). Thus, the voltage difference between data electrode Dk and scan electrode SC1 exceeds the discharge start voltage, and a discharge occurs between data electrode Dk and scan electrode SC1.

Since voltage Ve2 is applied to sustain electrode SU1-sustain electrode SUn, the voltage difference between sustain electrode SU1 and scan electrode SC1 is obtained by adding the difference between the wall voltage on sustain electrode SU1 and the wall voltage on scan electrode SC1 to a difference in externally applied voltage (voltage Ve2-voltage Va). At this time, setting voltage Ve2 to a voltage value slightly lower than the discharge start voltage can make a state where a discharge is likely to occur but does not actually occur between sustain electrode SU1 and scan electrode SC1.

With this setting, the discharge caused between data electrode Dk and scan electrode SC1 can trigger a discharge between the areas of sustain electrode SU1 and scan electrode SC1 intersecting data electrode Dk. Thus, an address discharge occurs in the discharge cells to be lit. Positive wall voltage accumulates on scan electrode SC1 and negative wall voltage accumulates on sustain electrode SU1. Negative wall voltage also accumulates on data electrode Dk.

In this manner, the address operation is performed so as to cause the address discharge in the discharge cells to be lit in the first line and accumulate wall voltages on the respective electrodes. In contrast, the voltage in the intersecting parts of scan electrode SC1 and data electrodes 32 applied with no address pulse does not exceed the discharge start voltage, and thus no address discharge occurs. The above address operation is repeated until the operation reaches the discharge cells in the n-th line, and the address period is completed.

In the subsequent sustain period, sustain pulses equal in number to the luminance weight multiplied by a predetermined luminance magnification are applied alternately to display electrode pairs 24. Thereby, a sustain discharge occurs in the discharge cells having undergone the address discharge, and causes the discharge cells to be lit.

In this sustain period, first, a sustain pulse at positive voltage Vs is applied to scan electrode SC1-scan electrode SCn and a ground electric potential as a base potential, i.e. 0 (V), is applied to sustain electrode SU1-sustain electrode SUn. Then, in the discharge cells having undergone the address discharge, the voltage difference between scan electrode SCi and sustain electrode SUi is obtained by adding the difference between the wall voltage on scan electrode SCi and the wall voltage on sustain electrode SUi to sustain pulse voltage Vs.

Thereby, the voltage difference between scan electrode SCi and sustain electrode SUi exceeds the discharge start voltage, and a sustain discharge occurs between scan electrode SCi and sustain electrode SUi. Then, ultraviolet rays generated by this discharge cause phosphor layers 35 to emit light. With this discharge, negative wall voltage accumulates on scan electrode SCi, and positive wall voltage accumulates on sustain electrode SUi. Positive wall voltage also accumulates on data electrode Dk. In the discharge cells having undergone no address discharge in the address period, no sustain discharge occurs and the wall voltage at the completion of the initializing period is maintained.

Subsequently, 0 (V) as the base electric potential is applied to scan electrode SC1-scan electrode SCn, and a sustain pulse is applied to sustain electrode SU1-sustain electrode SUn. In the discharge cell having undergone the sustain discharge, the voltage difference between sustain electrode SUi and scan electrode SCi exceeds the discharge start voltage. Thereby, a sustain discharge occurs between sustain electrode SUi and scan electrode SCi again. Thus, negative wall voltage accumulates on sustain electrode SUi, and positive wall voltage accumulates on scan electrode SCi.

Similarly, sustain pulses equal in number to the luminance weight multiplied by the luminance magnification are applied alternately to scan electrode SC1-scan electrode SCn and sustain electrode SU1-sustain electrode SUn. Thereby, the sustain discharge is continued in the discharge cells having undergone the address discharge in the address period.

After the sustain pulses have been generated in the sustain period, scan electrode SC1-scan electrode SCn are applied with a ramp waveform voltage that gently rises from 0 (V) toward voltage Vers while sustain electrode SU1-sustain electrode SUn and data electrode D1-data electrode Dm are applied with 0 (V). Hereinafter, this ramp waveform voltage is referred to as “erasing ramp voltage L3”.

Erasing ramp voltage L3 is set at a gradient steeper than that of up-ramp voltage L1. Examples of the gradient of erasing ramp voltage L3 include a numerical value of approximately 10 V/μsec. Voltage Vers is set to a voltage exceeding the discharge start voltage. Thereby, a weak discharge occurs between sustain electrode SUi and scan electrode SCi in a discharge cell having undergone the sustain discharge. This weak discharge continuously occurs while the voltage applied to scan electrode SC1-scan electrode SCn is rising above the discharge start voltage.

At this time, the charged particles generated by this weak discharge accumulate on sustain electrode SUi and scan electrode SCi so as to reduce the voltage difference between sustain electrode SUi and scan electrode SCi. Therefore, in a discharge cell having undergone the sustain discharge, a part or the whole of the wall voltage on scan electrode SCi and sustain electrode SUi is erased while the positive wall voltage is left on data electrode Dk. That is, the discharge caused by erasing ramp voltage L3 works as an “erasing discharge” for erasing unnecessary wall charge accumulated in the discharge cell having undergone the sustain discharge.

After the rising voltage has reached predetermined voltage Vers, the voltage applied to scan electrode SC1-scan electrode SCn is lowered to 0 (V) as the base electric potential. Thus, the sustain operation in the sustain period is completed.

In the initializing period of the second SF, the respective electrodes are applied with driving voltage waveforms where those in the first half of the initializing period of the first SF are omitted. Specifically, sustain electrode SU1-sustain electrode SUn are applied with voltage Ve1, and data electrode D1-data electrode Dm are applied with 0 (V). Scan electrode SC1-scan electrode SCn are applied with down-ramp voltage L4, which gently falls from voltage Vi3′ (e.g. voltage 0 (V)) lower than the discharge start voltage toward negative voltage Vi4 exceeding the discharge start voltage. Examples of the gradient of this down-ramp voltage L4 include a numerical value of approximately −2.5 V/μsec.

This voltage application causes a weak initializing discharge in the discharge cells having undergone a sustain discharge in the sustain period of the immediately preceding subfield (the first SF in FIG. 3). This weak discharge reduces the wall voltage on scan electrode SCi and sustain electrode SUi, and adjusts the wall voltage on data electrode Dk to a value appropriate for the address operation. In contrast, in the discharge cells having undergone no sustain discharge in the sustain period of the immediately preceding subfield, no initializing discharge occurs, and the wall charge at the completion of the initializing period of the immediately preceding subfield is maintained. In this manner, the initializing operation in the second SF is a selective initializing operation for causing an initializing discharge in the discharge cells having undergone a sustain discharge in the sustain period of the immediately preceding subfield.

In the address period and the sustain period of the second SF, the respective electrodes are applied with driving voltage waveforms same as those in the address period and the sustain period of the first SF except for the number of sustain pulses. In the third SF and those thereafter, the respective electrodes are applied with the driving voltage waveforms same as those in the second SF except for the number of sustain pulses.

The above description has outlined the driving voltage waveforms applied to the respective electrodes of panel 10 in this exemplary embodiment.

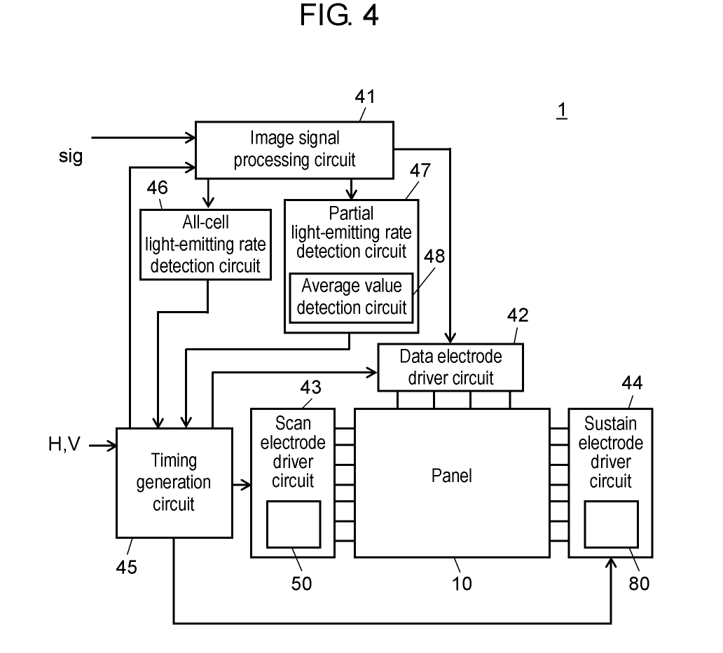

Next, a configuration of a plasma display apparatus in this exemplary embodiment is described. FIG. 4 is a circuit block diagram of plasma display apparatus 1 in accordance with the first exemplary embodiment of the present invention.

Plasma display apparatus 1 includes the following elements:

panel 10;

image signal processing circuit 41;

data electrode driver circuit 42;

scan electrode driver circuit 43;

sustain electrode driver circuit 44;

timing generation circuit 45;

all-cell light-emitting rate detection circuit 46;

partial light-emitting rate detection circuit 47; and

electric power supply circuits (not shown) for supplying electric power necessary for each circuit block.

Image signal processing circuit 41 allocates gradation values to the respective discharge cells, based on input image signal sig. The image signal processing circuit converts the gradation values into image data representing light emission and no light emission in each subfield.

For instance, when input image signal sig includes an R signal, a G signal, and a B signal, the image signal processing circuit allocates the R, G, and B gradation values to the respective discharge cells, based on the R signal, the G signal, and the B signal. When input image signal sig includes a luminance signal (Y signal) and a chroma signal (C signal, R-Y signal and B-Y signal, u signal and v signal, or the like), the R signal, the G signal, and the B signal are calculated based on the luminance signal and the chroma signal, and thereafter the R, G, and B gradation values (gradation values represented in one field) are allocated to the respective discharge cells. Then, the R, G, and B gradation values allocated to the respective discharge cells are converted into image data representing light emission and no light emission in each subfield.

All-cell light-emitting rate detection circuit 46 detects a rate of the number of discharge cells to be lit with respect to the number of all the discharge cells on the image display surface of panel 10, as an “all-cell light-emitting rate”, based on the image data in each subfield. Then, the all-cell light-emitting rate detection circuit outputs a signal representing the detected all-cell light-emitting rate to timing generation circuit 45.

Partial light-emitting rate detection circuit 47 divides the image display surface of panel 10 into a plurality of regions, and detects a rate of the number of discharge cells to be lit with respect to the number of all the discharge cells in each of the regions, in each subfield, as a “partial light-emitting rate”, based on the image data in each subfield. Partial light-emitting rate detection circuit 47 may detect a region that is formed of a plurality of scan electrodes 22 connected to one of integrated circuits (ICs) for driving scan electrodes 22 (hereinafter referred to as “scan ICs”), for example. In this exemplary embodiment, the partial light-emitting rate detection circuit detects a partial light-emitting rate in one display electrode pair 24, as one region.

Partial light-emitting rate detection circuit 47 has average value detection circuit 48. Average value detection circuit 48 compares a partial light-emitting rate detected in partial light-emitting rate detection circuit 47 with a predetermined threshold (hereinafter referred to as “partial light-emitting rate threshold”). Then, the average value detection circuit calculates an average value of the partial light-emitting rates of display electrode pairs 24 except display electrode pairs 24 whose partial light-emitting rates are equal to or lower than the partial light-emitting rate threshold. That is, the average value detection circuit calculates an average value of the partial light-emitting rates of display electrode pairs 24 whose partial light-emitting rates exceed the partial light-emitting rate threshold, in each subfield, and outputs a signal representing the result to timing generation circuit 45. For instance, when the number of display electrode pairs 24 in panel 10 is 1080 and the partial light-emitting rates of 200 display electrode pairs 24 are equal to or lower than the v in a subfield, the average value of the partial light-emitting rates of 880 display electrode pairs 24 whose partial light-emitting rates are higher than the partial light-emitting rate threshold is calculated.

In this exemplary embodiment, the partial light-emitting rate threshold is set to “0%”. This is intended to exclude display electrode pairs 24 where substantially no discharge cell is lit, when the average value of the partial light-emitting rates is calculated.

However, in the present invention, the partial light-emitting rate threshold is not limited to the above numerical value. Preferably, the partial light-emitting rate threshold is set to a value optimum for the characteristics of panel 10, the specifications of plasma display apparatus 1, or the like.

In this exemplary embodiment, when an all-cell light-emitting rate and a partial light-emitting rate are calculated, a normalized arithmetic for percentage display (% display) is performed. However, the normalized arithmetic does not need to be always performed. For example, the calculated number of lit discharge cells to be lit may be used as an all-cell light-emitting rate and a partial light-emitting rate. Hereinafter, a discharge cell to be lit is also denoted as “lit cell”, and a discharge cell not to be lit as “unlit cell”.

Timing generation circuit 45 generates various timing signals for controlling the operation of each circuit block in response to horizontal synchronization signal H, vertical synchronization signal V, and the output from all-cell light-emitting rate detection circuit 46 and partial light-emitting rate detection circuit 47. The timing generation circuit supplies the generated timing signals to each circuit block (image signal processing circuit 41, data electrode driver circuit 42, scan electrode driver circuit 43, sustain electrode driver circuit 44, or the like).

In this exemplary embodiment, as described above, the number of sustain pulses is changed based on an all-cell light-emitting rate and an average value of partial light-emitting rates. Specifically, the number of sustain pulses is changed in the following manner. Based on the input image signal and the luminance weight set for each subfield, the number of sustain pulses set in timing generation circuit 45 is corrected, using a correction coefficient based on the all-cell light-emitting rate and the average value of partial light-emitting rates. For this purpose, timing generation circuit 45 has a number-of-sustain-pulses corrector (not shown) capable of correcting the number of sustain pulses based on the all-cell light-emitting rate and the average value of partial light-emitting rates.

In this exemplary embodiment, the number-of-sustain-pulses corrector includes a lookup table. The lookup table is capable of storing a plurality of different correction coefficients correlated with all-cell light-emitting rates and partial light-emitting rates, and reading out one of the correction coefficients based on an all-cell light-emitting rate and an average value of partial light-emitting rates. This configuration is detailed later. However, the present invention is not limited to this configuration, and any configuration may be used as long as the configuration performs the similar operation.

Scan electrode driver circuit 43 has an initializing waveform generation circuit (not shown), sustain pulse generation circuit 50, and a scan pulse generation circuit (not shown). The initializing waveform generation circuit generates initializing waveforms to be applied to scan electrode SC1-scan electrode SCn in the initializing periods. Sustain pulse generation circuit 50 generates sustain pulses to be applied to scan electrode SC1-scan electrode SCn in the sustain periods. The scan pulse generation circuit has a plurality of scan electrode driver ICs (scan ICs) and generates scan pulses to be applied to scan electrode SC1-scan electrode SCn in the address periods. Scan electrode driver circuit 43 drives each of scan electrode SC1-scan electrode SCn, in response to the timing signals supplied from timing generation circuit 45.

Data electrode driver circuit 42 converts data forming image data in each subfield into signals corresponding to each of data electrode D1-data electrode Dm. The data electrode driver circuit drives each of data electrode D1-data electrode Dm in response to the above signals and the timing signals supplied from timing generation circuit 45.

Sustain electrode driver circuit 44 has sustain pulse generation circuit 80 and a circuit for generating voltage Ve1 and voltage Ve2 (not shown), and drives sustain electrode SU1-sustain electrode SUn in response to the timing signals supplied from timing generation circuit 45.

Next, scan electrode driver circuit 43 and the operation thereof are detailed. In the following description, the operation of turning on a switching element is denoted as “ON”, and the operation of turning off a switching element is denoted as “OFF”. The signal for setting a switching element to ON is denoted as “Hi”, and the signal for setting a switching element to OFF is denoted as “Lo”.

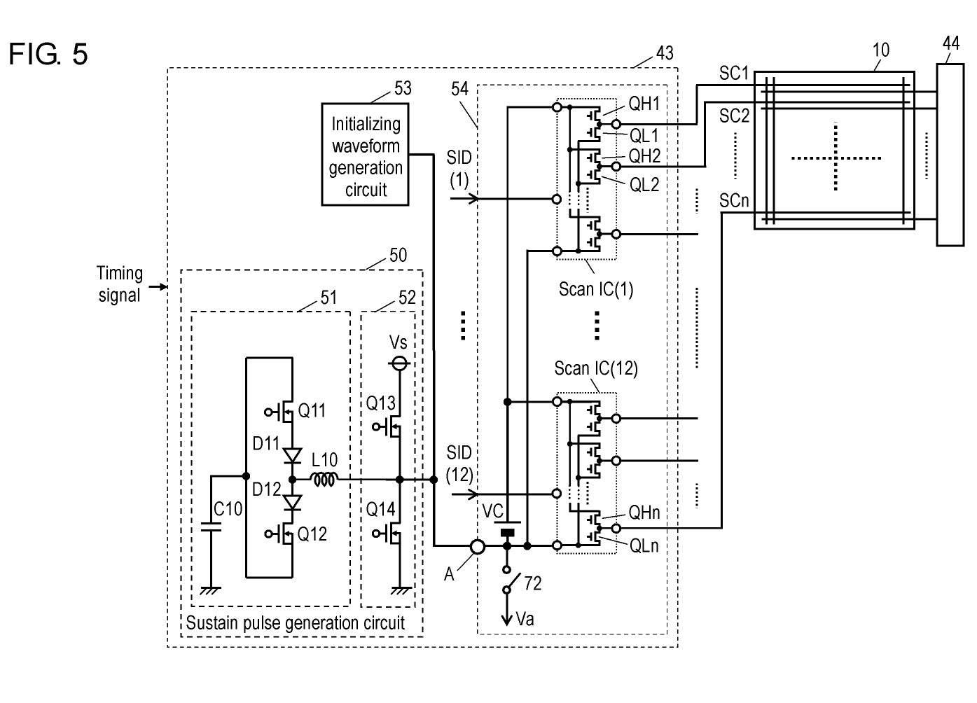

FIG. 5 is a circuit diagram showing a configuration of scan electrode driver circuit 43 of plasma display apparatus 1 in accordance with the first exemplary embodiment of the present invention. Scan electrode driver circuit 43 has sustain pulse generation circuit 50 on the side of scan electrodes 22, initializing waveform generation circuit 53, and scan pulse generation circuit 54. The output terminals of scan pulse generation circuit 54 are connected to respective scan electrode SC1-scan electrode SCn of panel 10. This is intended to apply scan pulses separately to each of scan electrodes 22 in the address periods.

Initializing waveform generation circuit 53 raises or lowers reference electric potential A of scan pulse generation circuit 54 in a ramp form so as to generate initializing waveforms of FIG. 3 in the initializing periods. Reference electric potential A is a voltage input to scan pulse generation circuit 54 as shown in FIG. 5.

Sustain pulse generation circuit 50 has power recovery circuit 51 and clamp circuit 52.

Power recovery circuit 51 has power recovery capacitor C10, switching element Q11, switching element Q12, blocking diode D11, blocking diode D12, and resonance inductor L10. The power recovery circuit causes LC resonance between interelectrode capacitance Cp and inductor L10 so as to cause a sustain pulse to rise and fall.

Clamp circuit 52 has switching element Q13 for clamping scan electrode SC1-scan electrode SCn to voltage Vs, and switching element Q14 for clamping scan electrode SC1-scan electrode SCn to voltage 0 (V) as the base electric potential. The clamp circuit connects scan electrode SC1-scan electrode SCn to electric power supply VS via switching element Q13 and clamps scan electrode SC1-scan electrode SCn to voltage Vs. The clamp circuit clamps scan electrode SC1-scan electrode SCn to the ground electric potential via switching element Q14 and clamps scan electrode SC1-scan electrode SCn to 0 (V).

Sustain pulse generation circuit 50 operates power recovery circuit 51 and clamp circuit 52 by switching on and off switching element Q11, switching element Q12, switching element Q13, and switching element Q14, in response to the timing signals supplied from timing generation circuit 45. Thus, the sustain pulse generation circuit generates sustain pulses.

For instance, when a sustain pulse is caused to rise, switching element Q11 is turned on to cause resonance between interelectrode capacitance Cp and inductor L10 such that electric power is supplied from power recovery capacitor C10 to scan electrode SC1-scan electrode SCn through switching element Q11, diode D11, and inductor L10. At a point when the voltage of scan electrode SC1-scan electrode SCn approaches voltage Vs, switching element Q13 is turned on such that the circuit for driving scan electrode SC1-scan electrode SCn is switched from power recovery circuit 51 to clamp circuit 52 so as to clamp scan electrode SC1-scan electrode SC to voltage Vs.

Inversely, when the sustain pulse is caused to fall, switching element Q12 is turned on to cause resonance between interelectrode capacitance Cp and inductor L10 such that electric power is recovered from interelectrode capacitance Cp to power recovery capacitor C10 through inductor L10, diode D12, and switching element Q12. At a point when the voltage of scan electrode SC1-scan electrode SCn approaches 0 (V), switching element Q14 is turned on such that the circuit for driving scan electrode SC1-scan electrode SCn is switched from power recovery circuit 51 to clamp circuit 52 so as to clamp scan electrode SC1-scan electrode SCn to the base electric potential, 0 (V).

These switching elements can be formed of generally known devices, such as a metal-oxide-semiconductor field-effect transistor (MOSFET) and an insulated gate bipolar transistor (IGBT).

Scan pulse generation circuit 54 includes the following elements:

switching element 72 for connecting reference electric potential A to negative voltage Va in the address periods;

electric power supply VC for generating voltage Vc; and

switching element QH1-switching element QHn and switching element QL1-switching element QLn for applying a scan pulse to n scan electrode SC1-scan electrode SCn, respectively.

Switching element QH1-switching element QHn and switching element QL1-switching element QLn are grouped in a plurality of outputs and formed into ICs. These ICs are scan ICs. By setting switching element QHi to OFF and setting switching element QLi to ON, a scan pulse at negative voltage Va is applied to scan electrode SCi via switching element QLi.

While initializing waveform generation circuit 53 or sustain pulse generation circuit 50 is operated, each of scan electrode SC1-scan electrode SCn is applied with an initializing waveform or a sustain pulse via switching element QL1-switching element QLn by setting switching element QH1-switching element QHn to OFF and switching element QL1-switching element QLn to ON, respectively.

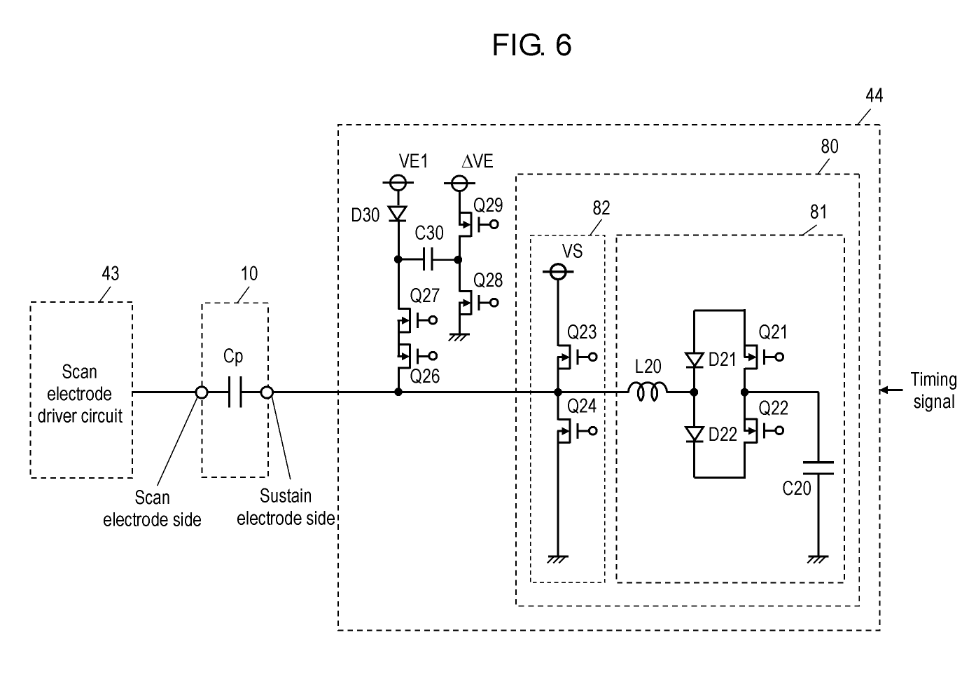

FIG. 6 is a circuit diagram showing a configuration of sustain electrode driver circuit 44 of plasma display apparatus 1 in accordance with the first exemplary embodiment of the present invention. In FIG. 6, the interelectrode capacitance of panel 10 is shown as Cp, and the circuit diagram of scan electrode driver circuit 43 is omitted.

Sustain electrode driver circuit 44 has sustain pulse generation circuit 80 substantially identical in configuration to sustain pulse generation circuit 50. Sustain pulse generation circuit 80 has power recovery circuit 81 and clamp circuit 82, and is connected to sustain electrode SU1-sustian electrode SUn of panel 10. In this manner, the output voltage of sustain electrode driver circuit 44 is connected in parallel with all sustain electrodes 23, and sustain electrode driver circuit 44 drives all sustain electrodes 23 collectively. This is because sustain electrodes 23 do not need to be driven separately in the address periods and the sustain periods unlike scan electrodes 22, and it is only necessary to apply the driving voltages to all sustain electrodes 23 simultaneously.

Power recovery circuit 81 has power recovery capacitor C20, switching element Q21, switching element Q22, blocking diode D21, blocking diode D22, and resonance inductor L20. Clamp circuit 82 has switching element Q23 for clamping sustain electrode SU1-sustain electrode SUn to voltage Vs, and switching element Q24 for clamping sustain electrode SU1-sustain electrode SUn to the ground electric potential (voltage 0 (V)).

Sustain pulse generation circuit 80 generates sustain pulses by switching on and off each switching element, in response to the timing signals output from timing generation circuit 45. The operation of sustain pulse generation circuit 80 is similar to that of sustain pulse generation circuit 50, and thus the description is omitted.

Sustain electrode driver circuit 44 includes the following elements:

electric power supply VE1 for generating voltage Ve1;

switching element Q26 for applying voltage Ve1 to sustain electrode SU1-sustain electrode SUn;

switching element Q27;

electric power supply ΔVE for generating voltage ΔVe;

blocking diode D30;

pumping-up capacitor C30 for superimposing voltage ΔVe on voltage Ve1;

switching element Q28 for generating voltage Ve2 by superimposing voltage ΔVe on voltage Ve1; and

switching element Q29.

Next, a description is provided for a difference in the emission luminance caused by a change in drive load.

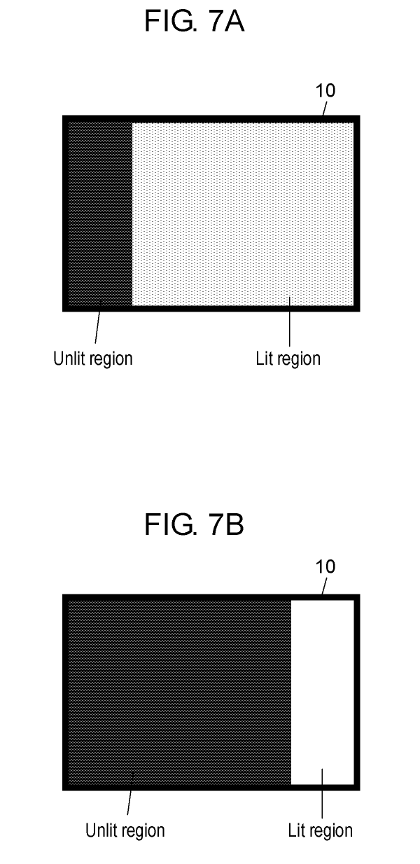

FIG. 7A and FIG. 7B are schematic diagrams for explaining a difference in the emission luminance caused by a change in drive load. Each of FIG. 7A and FIG. 7B schematically shows a light emission state of the image display surface of panel 10 in a subfield. The black region in each diagram shows a region where no discharge cell emits light (unlit region); the white region shows a region where discharge cells emit light (lit region). FIG. 7A is a diagram schematically showing the light emission state of panel 10 when the lit region is 80% of the image display surface. FIG. 7B is a diagram schematically showing the light emission state of panel 10 when the lit region is 20% of the image display surface. In FIG. 7A and FIG. 7B, display electrode pairs 24 are arranged in the line direction (in the direction parallel to the long side of panel 10, in the horizontal direction in the diagram) similarly to those in panel 10 of FIG. 2.

When panel 10 is lit with the area of the lit region changed as shown in FIG. 7A and FIG. 7B, the emission luminance in the lit region changes. This is considered for the following reason.

Since display electrode pairs 24 extend in the line direction, the number of lit cells on display electrode pairs 24 changes when panel 10 is lit with the lit region changed as shown in FIG. 7A and FIG. 7B. As the lit region is narrowed, the number of lit cells on display electrode pairs 24 becomes fewer. Thus, display electrode pairs 24 in the light emission state of FIG. 7B (with a small area of the lit region) have a drive load smaller than that of display electrode pairs 24 in the light emission state of FIG. 7A (with a large area of the lit region). Therefore, display electrode pairs 24 in the light emission state of FIG. 7B has a voltage drop smaller than that of display electrode pairs 24 in the light emission state of FIG. 7A. That is, it is considered that the sustain discharge in the lit region of FIG. 7B has a discharge intensity higher than the sustain discharge in the lit region of FIG. 7A. As a result, it is considered that the emission luminance is higher in the lit region of FIG. 7B than in the lit region of FIG. 7A.

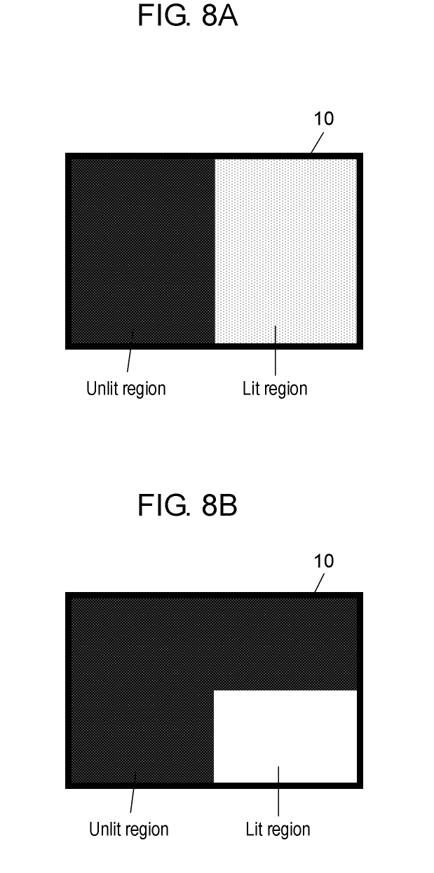

FIG. 8A and FIG. 8B are schematic diagrams for explaining another example of a difference in the emission luminance caused by a change in drive load. Each of FIG. 8A and FIG. 8B schematically shows a light emission state of the image display surface of panel 10 in a subfield. FIG. 8A is a diagram schematically showing the light emission state of panel 10 when the lit region is 50% of the image display surface. FIG. 8B is a diagram schematically showing the light emission state of panel 10 when the lit region is 25% of the image display surface.

FIG. 7A and FIG. 7B show an example where the partial light-emitting rate changes and the drive load of display electrode pairs 24 changes in the lit region. However, as shown in FIG. 8A and FIG. 8B, even when the partial light-emitting rate in the lit region does not change, the emission luminance in the lit region is changed by a change in the total number of lit cells, i.e. a change in all-cell light-emitting rate. This is mainly for the following reason. As described above, sustain electrode driver circuit 44 is connected in parallel with all sustain electrodes 23, and all sustain electrodes 23 are driven collectively by sustain electrode driver circuit 44. Thus, the change in all-cell light-emitting rate changes a voltage drop in the output voltage from sustain electrode driver circuit 44.

That is, in order to accurately estimate a change in the emission luminance in lit cells, it is preferable to detect both all-cell light-emitting rate and partial light-emitting rate of panel 10.

For the above reason, in this exemplary embodiment, an all-cell light-emitting rate and a partial light-emitting rate are detected for each subfield. In this exemplary embodiment, an average value of partial light-emitting rates is detected. That is, in this exemplary embodiment, an all-cell light-emitting rate and an average value of partial light-emitting rates are detected in each subfield.

Then, based on the detection result, the number of sustain pulses is changed in the sustain period of the subfield for which the above detection has been made. Thereby, the luminance caused in the sustain period is controlled. This luminance means a luminance obtained by accumulating light emissions caused in the sustain period, over the sustain period. Thus, the luminance of each subfield is maintained at a predetermined brightness. This can maintain the linearity of gradations in the display image, thereby enhancing the image display quality.

In this exemplary embodiment, the number of sustain pulses set based on an input image signal and a luminance weight is corrected, using a correction coefficient set based on an all-cell light-emitting rate and an average value of partial light-emitting rates. In the sustain period, a number of sustain pulses after correction are generated. Thus, the number of sustain pulses is controlled.

Next, a description is provided for an example of a method for setting a correction coefficient.

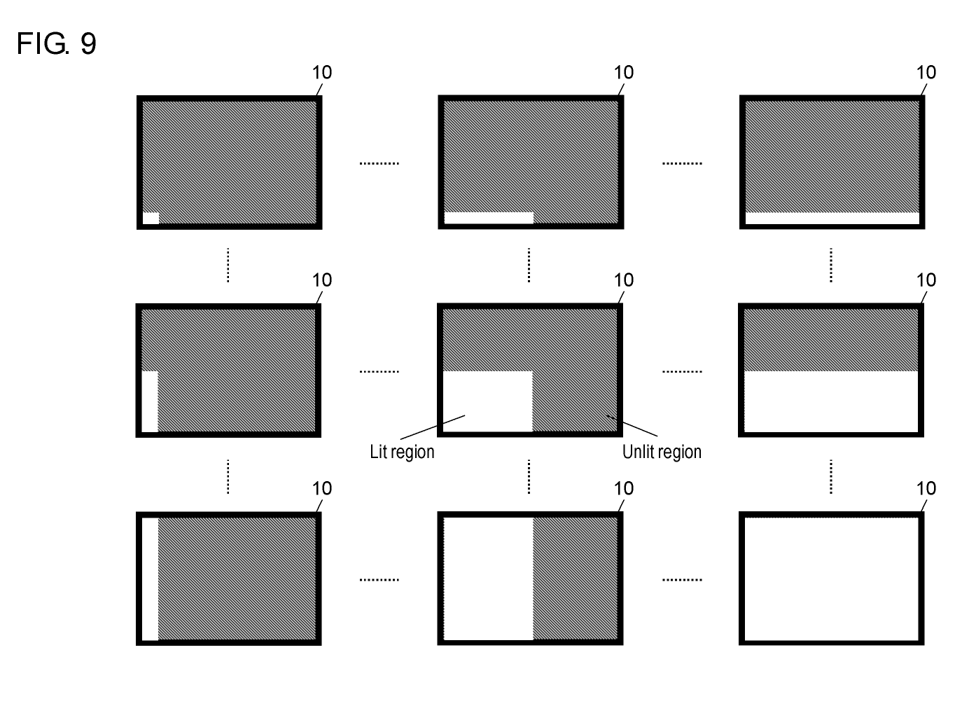

FIG. 9 is a diagram schematically showing measurement of emission luminance performed in order to set a correction coefficient in accordance with the first exemplary embodiment of the present invention. In this exemplary embodiment, in order to set a correction coefficient, an image having a lit region and an unlit region is displayed on panel 10. Then, while the emission luminance in the lit region is measured, the area of the lit region is gradually changed as shown in FIG. 9.

For instance, during display of an image where the lit region is 10% of the line direction (the horizontal direction in the diagram) and the column direction (the direction parallel to the short side of panel 10, the vertical direction in the diagram) of the image display surface of panel 10, the emission luminance of the lit region is measured. With this measurement, the emission luminance of an image whose all-cell light-emitting rate is 1% and whose average value of partial light-emitting rates is 10% can be obtained.

Next, during display of an image where the lit region is 10% of the line direction and 20% of the column direction of the image display surface of panel 10, the emission luminance of the lit region is measured. With this measurement, the emission luminance of an image whose all-cell light-emitting rate is 2% and whose average value of partial light-emitting rates is 10% can be obtained.

Similarly, while the lit region is gradually expanded, the emission luminance of each region is measured. By repeating these measuring operations, the emission luminances of a plurality of images having different all-cell light-emitting rates and average values of partial light-emitting rates can be obtained.

With a reference emission luminance set to “1”, each emission luminance is normalized. For instance, the emission luminance of an image whose all-cell light-emitting rate and average value of partial light-emitting rates are both 100% is set as a reference emission luminance, and each emission luminance is normalized. Next, the inverse number of each numerical value is calculated. In this exemplary embodiment, the calculation result is a correction coefficient. For instance, assume the emission luminance of an image whose all-cell light-emitting rate and average value of partial light-emitting rates are both 100% is set to “1”. In this case, when the emission luminance of an image whose all-cell light-emitting rate is 5% and whose average value of partial light-emitting rates is 40% is “1.25”, the inverse number of “1.25”, i.e. “0.80”, is a correction coefficient.

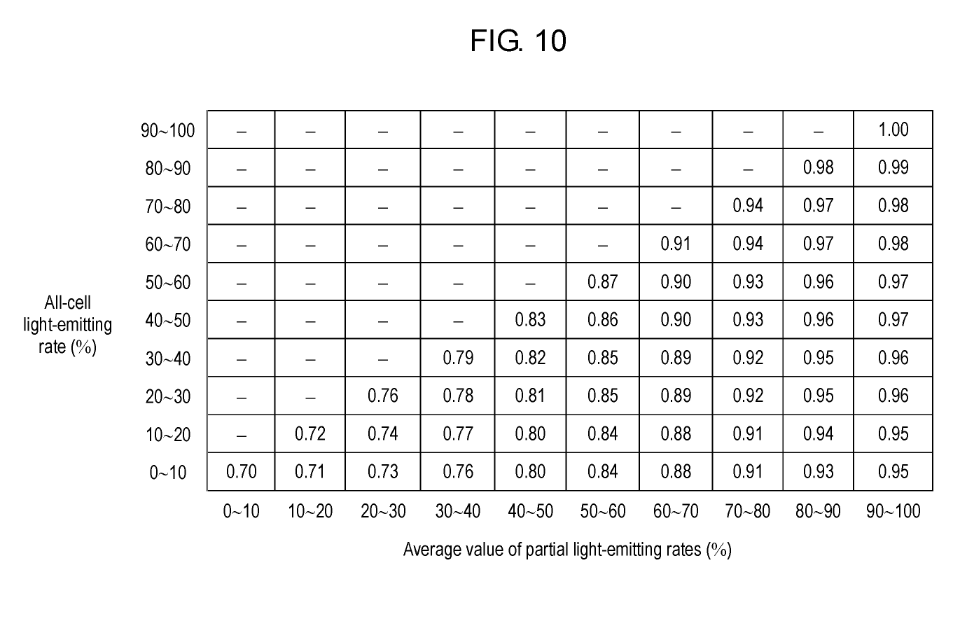

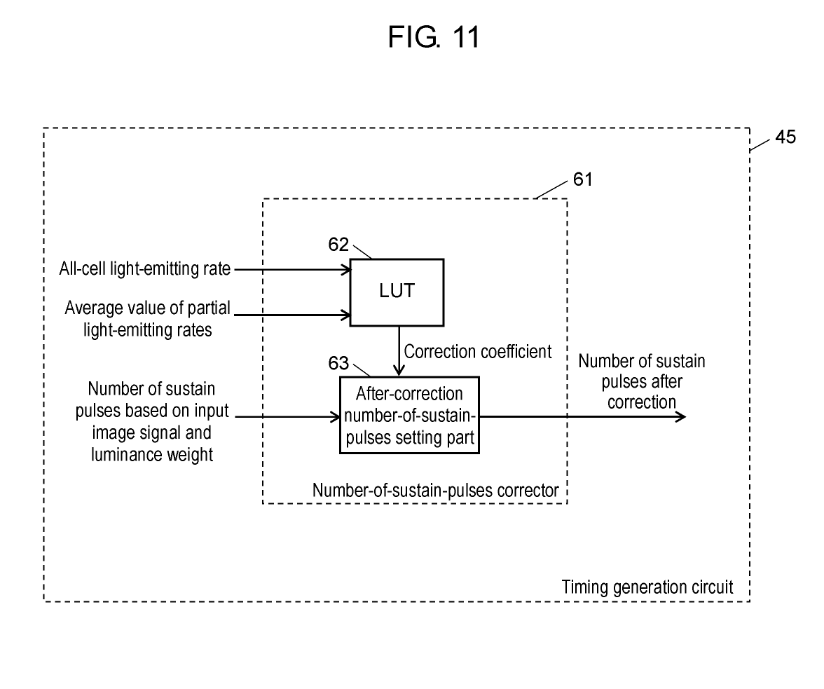

FIG. 10 is a table showing examples of correction coefficients in accordance with the first exemplary embodiment of the present invention. FIG. 11 is a circuit block diagram of number-of-sustain-pulses corrector 61 in accordance with the first exemplary embodiment of the present invention.

As shown in FIG. 11, timing generation circuit 45 in this exemplary embodiment has number-of-sustain-pulses corrector 61. Number-of-sustain-pulses corrector 61 includes lookup table 62 (denoted as “LUT” in the diagram) and after-correction number-of-sustain-pulses setting part 63. Lookup table 62 has a plurality of correction coefficients stored therein and reads out any one of correction coefficients based on an all-cell light-emitting rate and an average value of partial light-emitting rates. After-correction number-of-sustain-pulses setting part 63 multiplies the number of sustain pulses set based on an input image signal and a luminance weight (hereinafter also simply referred to as “the number of sustain pulses”) by the correction coefficient read out from lookup table 62, and outputs the result. This multiplication result is the number of sustain pulses after correction (after-correction number-of-sustain-pulses).

Timing generation circuit 45 generates a timing signal for controlling each circuit block such that sustain pulse generation circuit 50 and sustain pulse generation circuit 80 output sustain pulses equal in number to the sustain pulses after correction that are output from after-correction number-of-sustain-pulses setting part 63 in each subfield.

FIG. 10 shows correction coefficients corresponding to all-cell light-emitting rates divided into 10 steps in increments of 10% (0% to 100%) and average values (0% to 100%) of partial light-emitting rates divided into 10 steps in increments of 10% for each all-cell light-emitting rate. For instance, when the all-cell light-emitting rate is 100%, the average value of partial light-emitting rates is not lower than 100%. Such a combination that substantially does not occur is shown by “—” in the table. FIG. 10 only shows an example. In the present invention, the divisions of all-cell light-emitting rates and average values of partial light-emitting rates are not limited to those shown in FIG. 10. Each correction coefficient is not limited to a numerical value shown in FIG. 10.

As shown in FIG. 10, in this exemplary embodiment, the respective correction coefficients obtained by the above method are correlated with all-cell light-emitting rates and average values of partial light-emitting rates in matrix form, and stored in lookup table 62. Among the plurality of correction coefficients stored in lookup table 62, any one is read out based on the all-cell light-emitting rate and the average value of partial light-emitting rates detected in each subfield. Using the read-out correction coefficient, the number of sustain pulses in the subfield is corrected.

For instance, assume the number of sustain pulses set based on the input image signal and the luminance weight in the sixth SF is “128”, and the all-cell light-emitting rate is 5% and the average value of partial light-emitting rates is 45% in the sixth SF. The correction coefficient obtained from the data in lookup table 62 of FIG. 10 is “0.80”. Thus, after-correction number-of-sustain-pulses setting part 63 multiplies “128” by “0.80”. This multiplication result is “102”, and thus the number of sustain pulses in the sixth SF is “102”. This operation can make the luminance of the sixth SF 80% of that when the number of sustain pulses is “128”. Thus, the luminance of the sixth SF can be substantially equalized to the luminance when the all-cell light-emitting rate in the sixth SF is 100%. In this exemplary embodiment, the number of sustain pulses set based on the input image signal and the luminance weight in each subfield is corrected with a correction coefficient based on the all-cell light-emitting rate and the average value of partial light-emitting rates. Thereby, the luminance in each subfield can always be equalized to a predetermined luminance (e.g. a luminance when the all-cell light-emitting rate is 100%) regardless of the lighting states of the discharge cells.

As described above, in this exemplary embodiment, the all-cell light-emitting rate and the average value of partial light-emitting rates are detected in each subfield. From lookup table 62 that has stored a plurality of preset correction coefficients correlated with all-cell light-emitting rates and average values of partial light-emitting rates, one of the correction coefficients is read out based on the all-cell light-emitting rate and the average value of partial light-emitting rates detected for each subfield. Then, after-correction number-of-sustain-pulses setting part 63 corrects the number of sustain pulses set based on the input image signal and the luminance weight, using the correction coefficient. With this structure, a change in the emission luminance in each subfield can be estimated accurately, and the luminance of each subfield can always be maintained at a predetermined luminance (e.g. a luminance when the all-cell light-emitting rate is 100%) based on the estimation result. This can maintain the linearity of gradations in the display image, thereby enhancing the image display quality.

In the structure described in this exemplary embodiment, each correction coefficient is set such that the maximum value of the correction coefficients is “1”. In this case, the number of sustain pulses after correction is equal to or smaller than the number of sustain pulses before correction. This structure shows an example effective when the total time taken for the respective subfields reaches approximately one field and thus increasing the number of sustain pulses by further extending the sustain periods is difficult. However, the present invention is not limited to this structure. For instance, when the total time taken for the respective subfields does not reach one field and the number of sustain pulses can be increased by extending the sustain periods, e.g. when the luminance magnification is small, the following structure may be used. That is, each correction coefficient is set such that the maximum value of the correction coefficients is larger than “1”, and thus the number of sustain pulses is increased by the correction in some subfields. However, in any structure, it is preferable to set each correction coefficient such that the total time taken for the respective subfields after correction fit within one filed.

### Second Exemplary Embodiment

In the structure described in the first exemplary embodiment, respective correction coefficients are set such that the maximum value of the correction coefficients is “1”. In this case, the number of sustain pulses after correction is equal to or smaller than the number of sustain pulses before correction. When the number of sustain pulses after correction is smaller than that before correction, the luminance of the display image deceases. Then, in this exemplary embodiment, a description is provided for a structure where additional correction is made after the correction of the first exemplary embodiment such that the total number of sustain pulses to be generated in one field period is equivalent to the total number of sustain pulses in one field period before correction. In this exemplary embodiment, in order to distinguish between these corrections, the correction of the first exemplary embodiment is referred to as “first correction”, and the correction coefficient for use in the “first correction” as “first correction coefficient”. The additional correction shown in this exemplary embodiment is referred to as “second correction”, and the correction coefficient for use in the “second correction” as “second correction coefficient”. While the “first correction coefficient” is set for each subfield, this “second correction coefficient” is a correction coefficient common in all the subfields in one field.

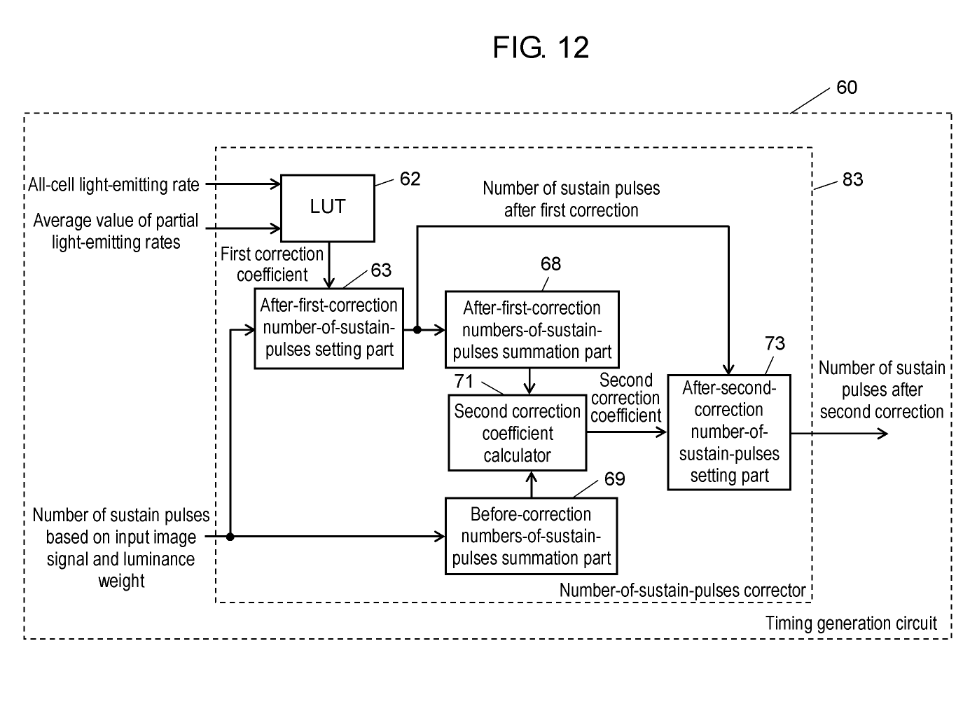

FIG. 12 is a diagram showing a part of the circuit blocks of timing generation circuit 60 in accordance with the second exemplary embodiment of the present invention. In FIG. 12, only the circuit blocks related to “first correction” and “second correction” are shown, and the other circuit blocks are omitted.

As shown in FIG. 12, timing generation circuit 60 of this exemplary embodiment has number-of-sustain-pulses corrector 83. Number-of-sustain-pulses corrector 83 includes lookup table 62 (denoted as “LUT” in the drawing), after-first-correction number-of-sustain-pulses setting part 63, after-first-correction numbers-of-sustain-pulses summation part 68, before-correction numbers-of-sustain-pulses summation part 69, second correction coefficient calculator 71, and after-second-correction number-of-sustain-pulses setting part 73. Lookup table 62 and after-first-correction number-of-sustain-pulses setting part 63 shown in FIG. 12 are identical in configuration and operation to lookup table 62 and after-correction number-of-sustain-pulses setting part 63 shown in FIG. 11, and thus the description thereof is omitted.

After-first-correction numbers-of-sustain-pulses summation part 68 cumulatively adds the number of sustain pulses after “first correction” in each subfield that is output from after-first-correction number-of-sustain-pulses setting part 63 over one field period. This operation calculates the total number of sustain pulses to be generated in one field period when the “first correction” is made.

Before-correction numbers-of-sustain-pulses summation part 69 cumulatively adds the number of sustain pulses in each subfield set based on the input image signal and the luminance weight, over one field period. This operation calculates the total number of sustain pulses to be generated in one field period when the “first correction” is not made (hereinafter also being referred to as “before ‘first correction’ ”).

Second correction coefficient calculator 71 divides a numerical value output from before-correction numbers-of-sustain-pulses summation part 69 by a numerical value output from after-first-correction number-of-sustain-pulses summation part 68. That is, the total number of sustain pulses to be generated in one field period when the “first correction” is not made is divided by the total number of sustain pulses to be generated in one field period when the “first correction” is made. This operation result is a “second correction coefficient” in this exemplary embodiment.

After-second-correction number-of-sustain-pulses setting part 73 multiplies a numerical value output from after-first-correction number-of-sustain-pulses setting part 63 by the “second correction coefficient” output from second correction coefficient calculator 71. That is, the number of sustain pulses after the “first correction” in each subfield is multiplied by the “second correction coefficient” output from second correction coefficient calculator 71. This multiplication result is “the number of sustain pulses after second correction”. After-second-correction number-of-sustain-pulses setting part 73 outputs the number of sustain pulses after the second correction.

Timing generation circuit 60 generates timing signals for controlling each circuit block such that sustain pulse generation circuit 50 and sustain pulse generation circuit 80 output sustain pulses equal in number to the sustain pulses after the second correction that are output from after-second-correction number-of-sustain-pulses setting part 73 in each subfield.

Next, a description is provided for the “second correction” in this exemplary embodiment, using specific numerical values.

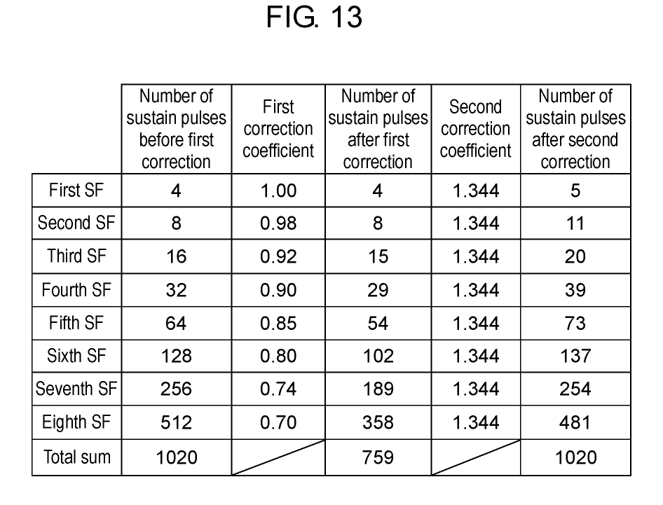

FIG. 13 is a table for explaining the “second correction” using specific numerical values in accordance with the second exemplary embodiment of the present invention. FIG. 13 shows the following values in each subfield: number of sustain pulses before “first correction”; “first correction coefficient”; number of sustain pulses after “first correction”; “second correction coefficient”; and number of sustain pulses after “second correction”.

For instance, when the respective numbers of sustain pulses generated based on input image signals and luminance weights are 4, 8, 16, 32, 64, 128, 256, and 512 in the first SF through the eighth SF, the total number of sustain pulses in one field period calculated in before-correction numbers-of-sustain-pulses summation part 69 is “1020”.

Assume that the respective “first correction coefficients” read out from lookup table 62 based on the all-cell light-emitting rates and the average values of partial light-emitting rates are 1.00, 0.98, 0.92, 0.90, 0.85, 0.80, 0.74, and 0.70 in the first SF through the eighth SF. In this case, the respective numbers of sustain pulses after the “first correction” in the first SF through the eighth SF calculated in after-first-correction number-of-sustain-pulses setting part 63 are 4, 8, 15, 29, 54, 102, 189, and 358 (rounded off to the nearest integers).

Therefore, the numerical value output from after-first-correction numbers-of-sustain-pulses summation part 68 as the total sum of these numerical values is “759”. This result shows that the number of sustain pulses generated after the “first correction” in one field period is “759”, which is “261” smaller than “1020”, i.e. the number of sustain pulses before the “first correction” in one field period.

Next, second correction coefficient calculator 71 divides “1020” calculated in before-correction numbers-of-sustain-pulses summation part 69 by “759” calculated in after-first-correction numbers-of-sustain-pulses summation part 68. Thus, the “second correction coefficient”=“1.344” is calculated.

Next, after-second-correction number-of-sustain-pulses setting part 73 multiplies “1.344” obtained as the “second correction coefficient” by the respective numbers of sustain pulses in the first SF through the eighth SF calculated in after-first-correction number-of-sustain-pulses setting part 63, i.e. 4, 8, 15, 29, 54, 102, 189, and 358.

With this calculation, the respective numbers of sustain pulses after the “second correction” in the first SF through the eighth SF are 5, 11, 20, 39, 73, 137, 254, and 481 (rounded off to the nearest integers). The total sum of these numerical values is “1020”. Thus, with the “second correction”, the number of sustain pulses in one field can be made “1020”, which is equal to the total number of sustain pulses before the “first correction”.

As described above, in this exemplary embodiment, in addition to the “first correction” of the first exemplary embodiment, the “second correction” is made so as to substantially equalize the total number of sustain pulses in one field period to that before the “first correction”. This structure can maintain the linearity of gradations in the display image and prevent a decrease in the brightness in the display image, thereby enhancing the image display quality.

In the structure shown in this exemplary embodiment, the total number of sustain pulses in one field period after the “second correction” can be substantially equalized to the total number of sustain pulses in one field period before the “first correction”. Thus, even when the total time taken for the respective subfields reaches approximately one field and increasing the number of sustain pulses by extending the sustain periods is difficult, the maximum value of the correction coefficients stored in lookup table 62 for the “first correction” can be set to a numerical value larger than “1”. This can make the set range of correction coefficients more flexible.

### Third Exemplary Embodiment

In the structure described in the second exemplary embodiment, “second correction” is made so as to substantially equalize the total number of sustain pulses to be generated in one field period to that before “first correction”. However, in this structure, the electric power consumption after the “second correction” can become higher than that before the “first correction”. Then, in this exemplary embodiment, a description is provided for a structure where additional correction is made after the “first correction” of the first exemplary embodiment so as to substantially equalize the estimated value of the electric power consumption in one field period to the estimated value of the electric power consumption in one field period before the “first correction”. In this exemplary embodiment, in order to distinguish between these corrections, the additional correction shown in this exemplary embodiment is referred to as “third correction”, and the correction coefficient for use in the “third correction” is referred to as “third correction coefficient”. The “third correction coefficient” is a correction coefficient set common in all the subfields in one field.

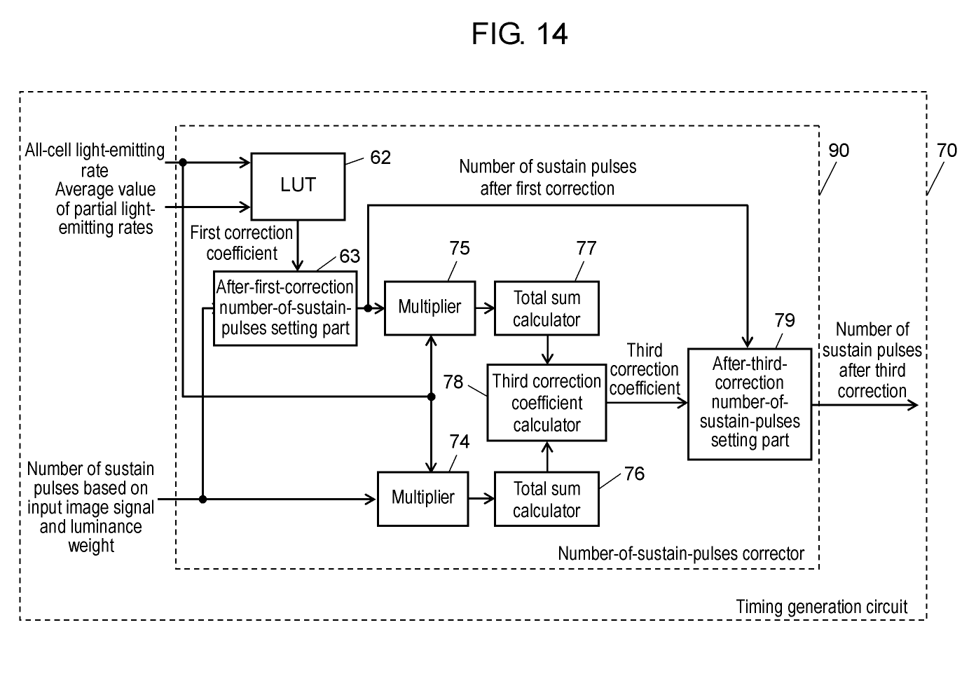

FIG. 14 is a diagram showing a part of the circuit blocks of timing generation circuit 70 in accordance with the third exemplary embodiment of the present invention. In FIG. 14, only the circuit blocks related to “first correction” and “third correction” are shown, and the other circuit blocks are omitted.

As shown in FIG. 14, timing generation circuit 70 of this exemplary embodiment has number-of-sustain-pulses corrector 90. Number-of-sustain-pulses corrector 90 includes lookup table 62 (denoted as “LUT” in the diagram), after-first-correction number-of-sustain-pulses setting part 63, multiplier 74, multiplier 75, total sum calculator 76, total sum calculator 77, third correction coefficient calculator 78, and after-third-correction number-of-sustain-pulses setting part 79. Lookup table 62 and after-first-correction number-of-sustain-pulses setting part 63 shown in FIG. 14 are identical in configuration and operation to lookup table 62 and after-correction number-of-sustain-pulses setting part 63 shown in FIG. 11, and thus the description thereof is omitted.

Multiplier 74 multiplies the number of sustain pulses in each subfield set based on an input image signal and a luminance weight by the all-cell light-emitting rate of the subfield. This operation calculates the estimated value of the electric power consumption in each sustain period in display of an image without “first correction”.

Total sum calculator 76 calculates the total sum of the multiplication results output from multiplier 74 in one field period. This operation calculates the total sum of the estimated values of the electric power consumption in the respective sustain periods in one field period in display of an image without the “first correction”.

Multiplier 75 multiplies the number of sustain pulses after the “first correction” in each subfield output from after-first-correction number-of-sustain-pulses setting part 63 by the all-cell light-emitting rate of the subfield. This operation calculates the estimated value of the electric power consumption in each sustain period in display of an image only with the “first correction”.

Total sum calculator 77 calculates the total sum of the multiplication results output from multiplier 75 in one field period. This operation calculates the total sum of the estimated values of the electric power consumption in the respective sustain periods in one field period in display of an image only with the “first correction”.

The numerical values calculated in total sum calculator 76 and total sum calculator 77 represent the estimated values of the electric power consumption in the sustain periods. However, this does not represent the electric power consumption in the strict meaning of the word. These estimated values are only approximate values obtained based on the following fact. That is, the electric power consumption in a sustain period with a large number of sustain pulses is higher than that with a small number of sustain pulses, and the electric power consumption in a sustain period at a high all-cell light-emitting rate is higher than that at a low all-cell light-emitting rate. However, the present invention is not limited to this structure. Other methods may be used to calculate the electric power consumption or calculate the estimated value of the electric power consumption. For instance, even when the all-cell light-emitting rate is 0% and no sustain discharge occurs on the image display surface, application of sustain pulses to scan electrodes 22 and sustain electrodes 23 consumes electric power that does not contribute to light emission, which is called reactive power. Then, an estimated value closer to the actual electric power consumption can be calculated in the following manner. An offset value in consideration of the reactive power is added to the all-cell light-emitting rate, this addition result is multiplied by the number of sustain pulses, and the obtained results are cumulatively added in one field period.

Third correction coefficient calculator 78 divides a numerical value output from total sum calculator 76 by a numerical value output from total sum calculator 77. That is, an estimated value of the electric power consumption in display of an image without the “first correction” is divided by an estimated value of the electric power consumption in display of an image only with the “first correction”. This operation result is a “third correction coefficient” in this exemplary embodiment.

After-third-correction number-of-sustain-pulses setting part 79 multiplies a numerical value output from after-first-correction number-of-sustain-pulses setting part 63 by the “third correction coefficient” output from third correction coefficient calculator 78. That is, the number of sustain pulses after the “first correction” in each subfield is multiplied by the “third correction coefficient” output from third correction coefficient calculator 78. This multiplication result is the number of sustain pulses after third correction. After-third-correction number-of-sustain-pulses setting part 79 outputs the number of sustain pulses after the third correction.

Timing generation circuit 70 generates timing signals for controlling each circuit block such that sustain pulse generation circuit 50 and sustain pulse generation circuit 80 output sustain pulses equal in number to the sustain pulses after the third correction that are output from after-third-correction number-of-sustain-pulses setting part 79 in each subfield.

Next, a description is provided for the “third correction” in this exemplary embodiment, using specific numerical values.

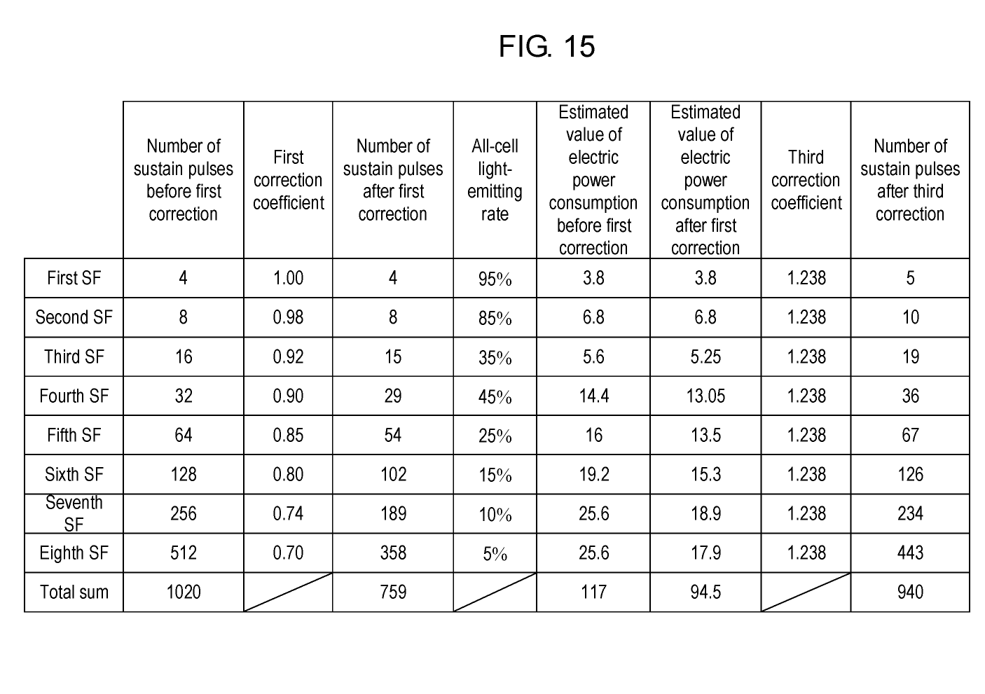

FIG. 15 is a table for explaining the “third correction” using specific numerical values in accordance with the third exemplary embodiment of the present invention. FIG. 15 shows the following values in each subfield: number of sustain pulses before “first correction”; “first correction coefficient”; number of sustain pulses after “first correction”; all-cell light-emitting rate; estimated value of electric power consumption before “first correction”; estimated value of electric power consumption after “first correction”; “third correction coefficient”; and number of sustain pulses after “third correction”.

For instance, assume the respective numbers of sustain pulses generated based on input image signals and luminance weights are 4, 8, 16, 32, 64, 128, 256, and 512 in the first SF through the eighth SF. Assume that the respective “first correction coefficients” read out from lookup table 62 based on the all-cell light-emitting rates and the average values of partial light-emitting rates are 1.00, 0.98, 0.92, 0.90, 0.85, 0.80, 0.74, and 0.70 in the first SF through the eighth SF. In this case, the respective numbers of sustain pulses after the “first correction” in the first SF through the eighth SF calculated in after-first-correction number-of-sustain-pulses setting part 63 are 4, 8, 15, 29, 54, 102, 189, and 358 (rounded off to the nearest integers).

Assume that the respective all-cell light-emitting rates in the first SF through the eighth SF are 95%, 85%, 35%, 45%, 25%, 15%, 10%, and 5%. In this case, the respective numerical values calculated in multiplier 74 as multiplication values of the numbers of sustain pulses before the “first correction” and the all-cell light-emitting rates in the first SF through the eighth SF are 3.8, 6.8, 5.6, 14.4, 16, 19.2, 25.6, and 25.6.

Thus, the numerical value output from total sum calculator 76 as the total sum of these values is “117”. That is, the total sum (approximate value) of the electric power consumption in the respective sustain periods in display of an image without the “first correction” is “117”.

Similarly, the respective numerical values calculated in multiplier 75 as multiplication values of the numbers of sustain pulses after the “first correction” and the all-cell light-emitting rates in the first SF through the eighth SF are 3.8, 6.8, 5.25, 13.05, 13.5, 15.3, 18.9, and 17.9.

Thus, the numerical value output from total sum calculator 77 as the total sum of these values is “94.5”. That is, the total sum (approximate value) of the electric power consumption in the respective sustain periods in display of an image only with the “first correction” is “94.5”.

These results show that the total sum (approximate value) of the electric power consumption in the respective sustain periods decreases from “117”, i.e. that in display of an image without the “first correction, to “94.5”, i.e. that in display of an image only with the “first correction”.

Next, third correction coefficient calculator 78 divides “117” calculated in total sum calculator 76 by “94.5” calculated in total sum calculator 77. Thus, the “third correction coefficient”=“1.238” is obtained.

Next, after-third-correction number-of-sustain-pulses setting part 79 multiplies “1.238” obtained as the “third correction coefficient” by the respective numbers of sustain pulses in the first SF through the eighth SF calculated in after-first-correction number-of-sustain-pulses setting part 63, i.e. 4, 8, 15, 29, 54, 102, 189, and 358.

With this calculation, the respective numbers of sustain pulses after the “third correction” in the first SF through the eighth SF are 5, 10, 19, 36, 67, 126, 234, and 443 (rounded off to the nearest integers). Though not shown in the table, the respective multiplication results of the numbers of sustain pulses after the “third correction” and the all-cell light-emitting rates in the first SF through the eighth SF are 4.75, 8.5, 6.65, 16.2, 16.75, 18.9, 23.4, and 22.15. The total sum of these values is “117.3”. Thus, with the “third correction”, the electric power consumption in one field period can be substantially equalized to the electric power consumption before the “first correction”. Further, the total number of sustain pulses in one field period can be made larger than that only with the “first correction”. This can prevent a decrease in the brightness in the display image, thereby enhancing the image display quality.

As described above, in this exemplary embodiment, in addition to the “first correction” of the first exemplary embodiment, “third correction” is made so as to substantially equalize the electric power consumption in one field period to that before the “first correction”. This structure can maintain the linearity of gradations in the display image, and prevent a decrease in the brightness in the display image while suppressing an increase in electric power consumption.

In the structure of this exemplary embodiment, the estimated value of the electric power consumption in one field period after the “third correction” can be substantially equalized to that before the “first correction”. Therefore, this structure can be used also in the structure where the maximum value of the correction coefficients stored in lookup table 62 is larger than “1”, and the estimated value of the electric power consumption in one field period after the “first correction” is larger than that before the “first correction”.

### Fourth Exemplary Embodiment

In the structure described in the second exemplary embodiment, “second correction” is made so as to substantially equalize the total number of sustain pulses in one field period to that before “first correction”. However, in this structure, the electric power consumption after the “second correction” can be larger than that before the “first correction”.

This is for the following reasons. As described in the first exemplary embodiment, a “first correction coefficient” is set for each subfield. As shown in FIG. 10, the “first correction coefficient” is larger at a larger all-cell light-emitting rate, and is smaller at a smaller all-cell light-emitting rate.

Thus, the following phenomenon occurs depending on the maximum value of the “first correction coefficient”. When the maximum value of the “first correction coefficient” is set to “1” as shown in the example of FIG. 13, the number of sustain pulses becomes only slightly smaller than that before the “first correction” in subfields having relatively large “first correction coefficients” (e.g. the first SF through the sixth SF in FIG. 13). In contrast, the number of sustain pluses becomes considerably smaller than that before the “first correction” in subfields having relatively small “first correction coefficients” (e.g. the seventh SF and the eighth SF in FIG. 13).

In the case where the maximum value of the “first correction coefficients” is “1”, the “first correction coefficient” in each subfield is equal to or smaller than “1”. Thus, the total number of sustain pulses in one field period after the “first correction” is equal to or smaller than the total number of sustain pulses before the “first correction” in one field period. This makes the “second correction coefficient” equal to or larger than “1”.

As described in the second exemplary embodiment, the “second correction coefficient” is common in all the subfields in one field, and thus is considered to cause the following phenomenon. The number of sustain pulses tends to become larger than that before the “first correction” in subfields having large all-cell light-emitting rates (e.g. the first SF through the sixth SF in FIG. 13). In contrast, the number of sustain pulses tends to become smaller than that before the “first correction” in subfields having small all-cell light-emitting rates (e.g. the seventh SF and the eighth SF in FIG. 13).

In the subfields having large all-cell light-emitting rates, the number of lit discharge cells is larger than that in the subfields having small all-cell light-emitting rates, and thus larger electric power is consumed in one sustain discharge.

That is, the “second correction” tends to make the number of sustain pulses larger than that before the “first correction” in subfields where large electric power is consumed in one sustain discharge (subfields having large all-cell light-emitting rates), and to make the number of sustain pulses smaller than that before the “first correction” in subfields where small electric power is consumed in one sustain discharge (subfields having small all-cell light-emitting rates). As a result, it is considered that the electric power consumption after the “second correction” can become larger than that before the “first correction”.

However, when the average picture level (APL) of an image signal is low, the electric power consumption of plasma display apparatus 1 is smaller than that when the APL is high, and thus a slight increase in the electric power consumption caused by the “second correction” does not cause a problem. On the contrary, in terms of enhancement of image display quality, it is preferable to display an image having a low APL more brightly. In contrast, when the APL is high, the electric power consumption of plasma display apparatus 1 increases and thus the “third correction” for preventing a decrease in the brightness in the display image while suppressing an increase in electric power consumption is preferable to the “second correction” for increasing the electric power consumption.

Then, in this exemplary embodiment, a description is provided for a structure where “fourth correction” is made, using a “fourth correction coefficient”, after the “first correction” shown in the first exemplary embodiment. The “fourth correction coefficient” is calculated by mixing the “second correction coefficient” and the “third correction coefficient” at a rate in response to the magnitude of the APL, and is a correction coefficient common in all the subfields in one field.

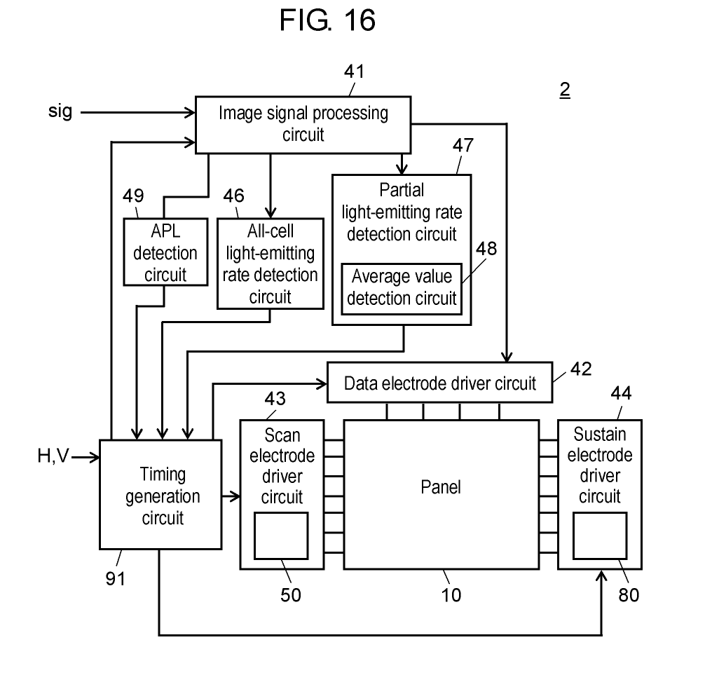

FIG. 16 is a circuit block diagram of plasma display apparatus 2 in accordance with the fourth exemplary embodiment of the present invention.

Plasma display apparatus 2 includes the following elements:

panel 10;

image signal processing circuit 41;

data electrode driver circuit 42;

scan electrode driver circuit 43;

sustain electrode driver circuit 44;

timing generation circuit 91;

all-cell light-emitting rate detection circuit 46;

partial light-emitting rate detection circuit 47;

APL detection circuit 49; and

electric power supply circuits (not shown) for supplying electric power necessary for each circuit block.

Each of the circuit blocks except APL detection circuit 49 and timing generation circuit 91 is identical in configuration and operation to that of the circuit block having the same name in FIG. 4 in the first exemplary embodiment.

APL detection circuit 49 detects an APL, using a generally-known technique for accumulating the luminance values of the input image signals over one field period, for example. The APL detection circuit transmits the detection result to timing generation circuit 91.

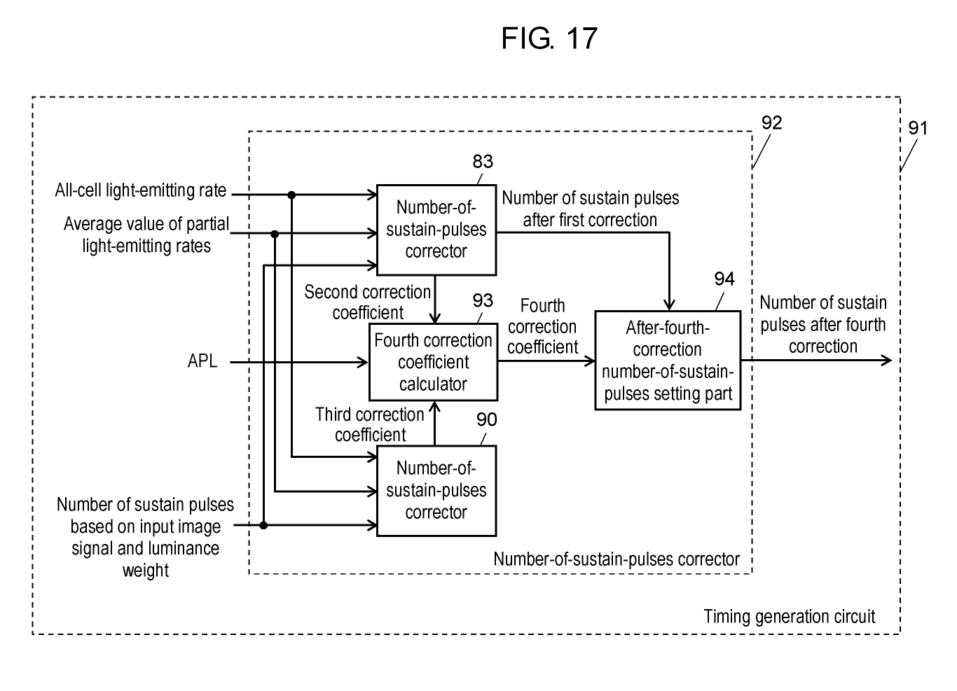

FIG. 17 is a diagram showing a part of the circuit blocks of timing generation circuit 91 in accordance with the fourth exemplary embodiment of the present invention. In FIG. 17, only the circuit blocks related to this exemplary embodiment are shown, and the other circuit blocks are omitted.

As shown in FIG. 17, timing generation circuit 91 of this exemplary embodiment has number-of-sustain-pulses corrector 92. Number-of-sustain-pulses corrector 92 includes number-of-sustain-pulses corrector 83, number-of-sustain-pulses corrector 90, fourth correction coefficient calculator 93, and after-fourth-correction number-of-sustain-pulses setting part 94. Number-of-sustain-pulses corrector 83 of FIG. 17 outputs a “second correction coefficient”, and is identical in configuration and operation to number-of-sustain-pulses corrector 83 of FIG. 12. Thus, the description thereof is omitted. Number-of-sustain-pulses corrector 90 of FIG. 17 outputs a “third correction coefficient”, and is identical in configuration and operation to number-of-sustain-pulses corrector 90 of FIG. 14. Thus, the description thereof is omitted.

Fourth correction coefficient calculator 93 mixes a “second correction coefficient” output from number-of-sustain-pulses corrector 83 and a “third correction coefficient” output from number-of-sustain-pulses corrector 90 in response to an APL. Specifically, when the APL is smaller than a first threshold (e.g. 20%), in order to give higher priority to enhancement of the luminance in the display image, the “second correction coefficient” is output as a “fourth correction coefficient”. When the APL is equal to or larger than a second threshold (e.g. 30%), which is larger than the first threshold, in order to give higher priority to suppression of electric power consumption, the “third correction coefficient” is output as the “fourth correction coefficient”. When the APL is equal to or larger than the first threshold and smaller than the second threshold, the “second correction coefficient” and the “third correction coefficient” are mixed at a rate in response to the magnitude of the APL, and the result is output as the “fourth correction coefficient”.

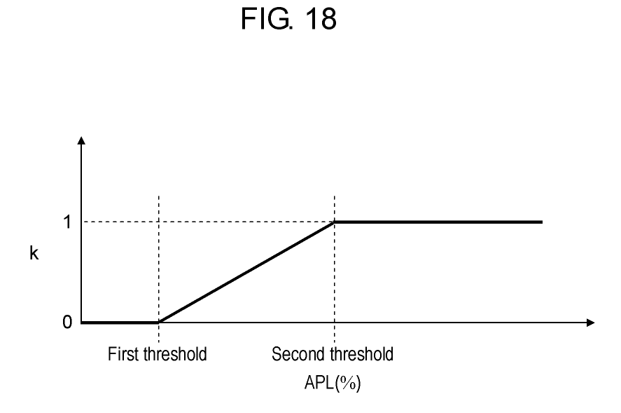

The methods for calculating the “fourth correction coefficient” include a method using variable k. FIG. 18 is a graph showing an example of setting of variable k in accordance with the fourth exemplary embodiment of the present invention. In FIG. 18, the horizontal axis shows an APL, and the vertical axis shows variable k.

For instance, when the APL is smaller than the first threshold, k=“0”. When the APL is equal to or larger than the second threshold, k=“1”. When the APL is equal to or larger than the first threshold and smaller than the second threshold, k=(APL-First threshold)/(Second threshold-First threshold). The “fourth correction coefficient” is calculated by substituting variable k obtained with the above calculating formula into the following calculating formula:

“Fourth correction coefficient”=(1−k)×“Second correction coefficient”+k×“Third correction coefficient”. Such a calculation method, for example, can be used as the method for calculating the “fourth correction coefficient”.

However, in the present invention, the method for calculating the “fourth correction coefficient” is not limited to the above method. Other methods, such as raising variable k to the power of 2 or ½, can be used to calculate the “fourth correction coefficient”.

After-fourth-correction number-of-sustain-pulses setting part 94 multiplies the number of sustain pulses after first correction output from after-first-correction number-of-sustain-pulses setting part 63 (not shown in FIG. 17) by the “fourth correction coefficient” output from fourth correction coefficient calculator 93, and outputs the multiplication result as the number of sustain pulses after the fourth correction.

Timing generation circuit 91 generates timing signals for controlling each circuit block such that sustain pulse generation circuit 50 and sustain pulse generation circuit 80 output sustain pulses equal in number to the sustain pulses after the fourth correction that are output from after-fourth-correction number-of-sustain-pulses setting part 94 in each subfield.

As described above, in this exemplary embodiment, in addition to the “first correction” of the first exemplary embodiment, the following correction is made. When the APL of an input image signal is low (the APL is smaller than the first threshold), the “second correction” is made so as to give higher priority to the brightness in the display image. When the APL of an input image signal is high (the APL is equal to or larger than the second threshold), the “third correction” is made so as to prevent a decrease in the brightness in the display image while suppressing an increase in electric power consumption. When the APL is equal to or larger than the first threshold and smaller than the second threshold, the “fourth correction” is made so as to mix the “second correction coefficient” and the “third correction coefficient” into the “fourth correction coefficient” at a rate in response to the magnitude of the APL. This structure can maintain the linearity of gradations in the display image, and prevent a decrease in the brightness in the display image while suppressing an increase in electric power consumption.

### Fifth Exemplary Embodiment

In the structures described in the second through the fourth exemplary embodiments, after the number of sustain pulses is corrected using the “first correction coefficient” set for each subfield, the number of sustain pulses is further corrected using a correction coefficient common in all the subfields in one field. (Hereinafter, for simplifying explanation, the correction made after the “first correction”, i.e. “second correction”, “third correction”, or “fourth correction”, is also generically referred to as “recorrection”. The “first correction” and the “recorrection” are also generically simply referred to as “correction”.)

The following phenomenon is experimentally verified in a generally-viewed dynamic image. The all-cell light-emitting rate tends to be relatively high in subfields having light luminance weights, and to be relatively low in subfields having heavy luminance weights. As shown in FIG. 10, the “first correction coefficient” is larger at the larger all-cell light-emitting rate, and smaller at the smaller all-cell light-emitting rate. Thus, it is considered that, in a generally-viewed dynamic image, the “first correction coefficient” tends to be relatively large in subfields having light luminance weights and relatively small in subfields having heavy luminance weights.

Thus, the following phenomenon occurs depending on the maximum value of the “first correction coefficient”. When the maximum value of the “first correction coefficient” is set to “1”, the amount of decrease in the number of sustain pulses after the “first correction” with respect to that before the “first correction” tends to be relatively small in subfields having light luminance weights, and relatively large in subfields having heavy luminance weights.

When the maximum value of the “first correction coefficient” is “1”, the “first correction coefficient” in each subfield is equal to or smaller than “1”. Thus, the total number of sustain pulses in one field period after the “first correction” is equal to or smaller than the total number of sustain pulses before the “first correction” in one field period. In that case, each of the “second correction coefficient” shown in the second exemplary embodiment, the “third correction coefficient” in the third exemplary embodiment, and the “fourth correction coefficient” in the fourth exemplary embodiment is equal to or larger than “1”.

Each of the “second correction coefficient”, the “third correction coefficient”, and the “fourth correction coefficient” is common in all the subfields in one field. Thus, the number of sustain pulses after the “correction” can be larger than that before the “correction” in subfields having light luminance weights, and can be smaller in subfields having heavy luminance weights. A description is provided for an example of this phenomenon, using specific numerical values. In the following description, for simplifying the description, the “recorrection” is only the “second correction”.

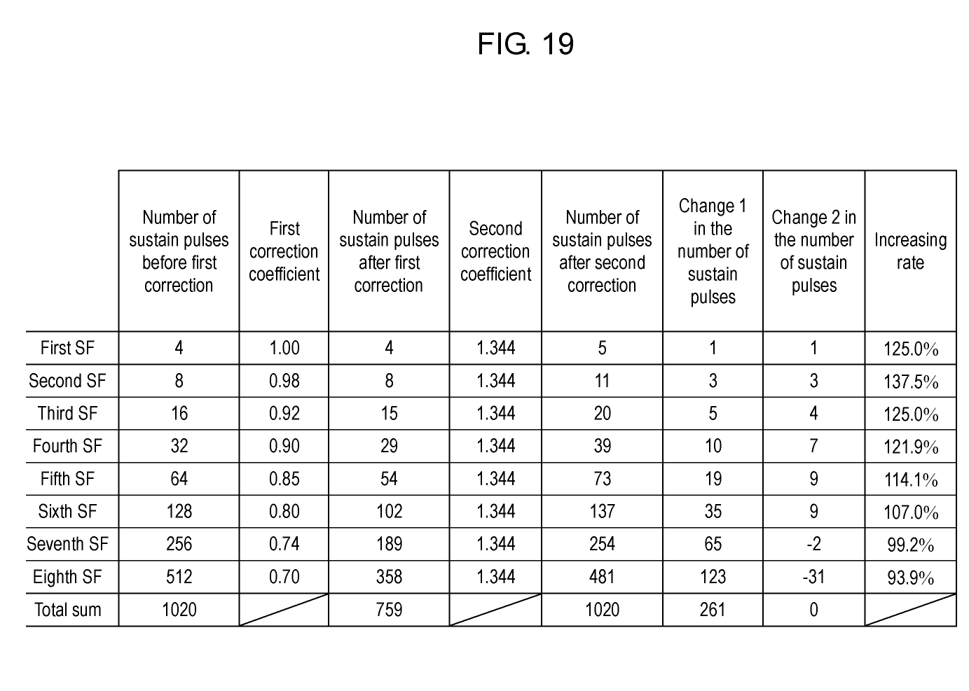

FIG. 19 is a table for comparing the number of sustain pulses before “first correction” with the number of sustain pulses after “second correction” in accordance with the exemplary embodiment of the present invention. FIG. 19 shows the following values in each subfield: number of sustain pulses before “first correction”; “first correction coefficient”; number of sustain pulses after “first correction”; “second correction coefficient”; number of sustain pulses after “second correction”; difference in the number of sustain pulses between after “first correction” and after “second correction” (“change 1 in the number of sustain pulses” in the table); difference in the number of sustain pulses between before “first correction” and after “second correction” (“change 2 in the number of sustain pulses” in the table); and increasing rate of the number of sustain pulses after “second correction” with respect to that before “first correction” (“increasing rate” in the table). In the example of FIG. 19, the numerical values of the number of subfields, the number of sustain pulses in each subfield, the “first correction coefficient”, and the “second correction coefficient” are equal to those shown in FIG. 13. The “first correction coefficient” is based on the assumption of a generally-viewed dynamic image. Thus, the first correction coefficient is set to a relatively large numerical value in subfields having light luminance weights where the all-cell light-emitting rates tend to be relatively high, and is set to a relatively small value in subfields having heavy luminance weights where the all-cell light-emitting rates tend to be relatively low.

As shown in FIG. 19, in subfields having light luminance weights where the all-cell light-emitting rates are high and thus the “first correction coefficients” tend to be relatively large, the number of sustain pulses changes between before and after the “first correction” with a low possibility. In the example of FIG. 19, the respective numbers of sustain pulses before the “first correction” are 4, 8, and 16, and the respective numbers of sustain pulses after the “first correction” are 4, 8, and 15 in the first SF, the second SF, and the third SF having light luminance weights. Thus, the number of sustain pulses substantially does not change between before and after the “first correction”.

In contrast, in subfields having heavy luminance weights where the all-cell light-emitting rates are low and thus the “first correction coefficients” tend to be relatively small, the number of sustain pulses tends to be considerably decreased by the “first correction”. In the example of FIG. 19, the respective numbers of sustain pulses before the “first correction” are 256 and 512, and the respective numbers of sustain pulses after the “first correction” are 189 and 358 in the seventh SF and the eighth SF having heavy luminance weights. Thus, in the seventh SF and the eighth SF, the respective numbers of sustain pulses after the “first correction” are considerably decreased by 67 and 154 with respect to the numbers of sustain pulses before the “first correction”.

On the other hand, the correction coefficient for use in the “recorrection” is common in all the subfields in one field. Thus, when the correction coefficient in the “recorrection” is larger than 1, the number of sustain pulses after the “recorrection” becomes larger than the number of sustain pulses before the “recorrection” in all the subfields. In the example of FIG. 19, the “second correction coefficient” is “1.344”, which is a numerical value larger than “1”. Therefore, the number of sustain pulses after the “recorrection” is larger than that before the “recorrection”. That is, the number of sustain pulses after the “second correction” is larger than that after the “first correction”.

At this time, depending on the magnitude of the “first correction coefficient”, the number of sustain pulses after the “recorrection” can be smaller than that before the “first correction. Inversely, the number of sustain pulses after the “recorrection” can be larger than that before the “first correction. In subfields having heavy luminance weights where the “first correction coefficient” tends to be relatively small, the number of sustain pulses after the “recorrection” tends to be smaller than that before the “first correction”. In subfields having light luminance weights where the “first correction coefficient” tends to be relatively large, the number of sustain pulses after the “recorrection” tends to be larger than that before the “first correction”.

In the example of FIG. 19, in the seventh SF and the eighth SF having heavy luminance weights, the respective numbers of sustain pulses after the “second correction” are decreased by 2 and 31 with respect to the numbers of sustain pulses before the “first correction”. In the first SF, the second SF and the third SF having light luminance weights, the respective numbers of sustain pulses after the “second correction” are increased by 1, 3, and 4 with respect to the numbers of sustain pulses before the “first correction”. This change is expressed as an increasing rate of the number of sustain pulses after the “second correction” with respect to the number of sustain pulses before the “first correction”. The respective increasing rates in the seventh SF and the eighth SF are 99.2% and 93.9%, and those in the first SF, the second SF, and the third SF are 125.0%, 137.5%, and 125.0%.

The numerical value representing this rate (“increasing rate” in FIG. 19) can be expressed as a numerical value obtained by multiplying the “first correction coefficient” by the “second correction coefficient” (or a correction coefficient for use in the “recorrection”) in the calculation. However, in subfields having light luminance weights, the difference between the calculated numerical value and the actual increasing rate of sustain pulses tends to be large. This is considered for the following reason. Subfields where a small numbers of sustain pulses are generated are more considerably affected by so-called round-off errors caused by dropping the fractional portion of the numbers in the process of calculation than subfields where a large numbers of sustain pulses are generated.

The above numerical values are only examples of the results obtained based on the correction coefficients set on the assumption of a generally-viewed dynamic image. However, a tendency similar to the above is also experimentally verified in a large number of dynamic images. That is, it is verified that the increasing rate of the number of sustain pulses after the “recorrection” with respect to that before the “first correction” tends to be higher in subfields having light luminance weights than in subfields having heavy luminance weights.

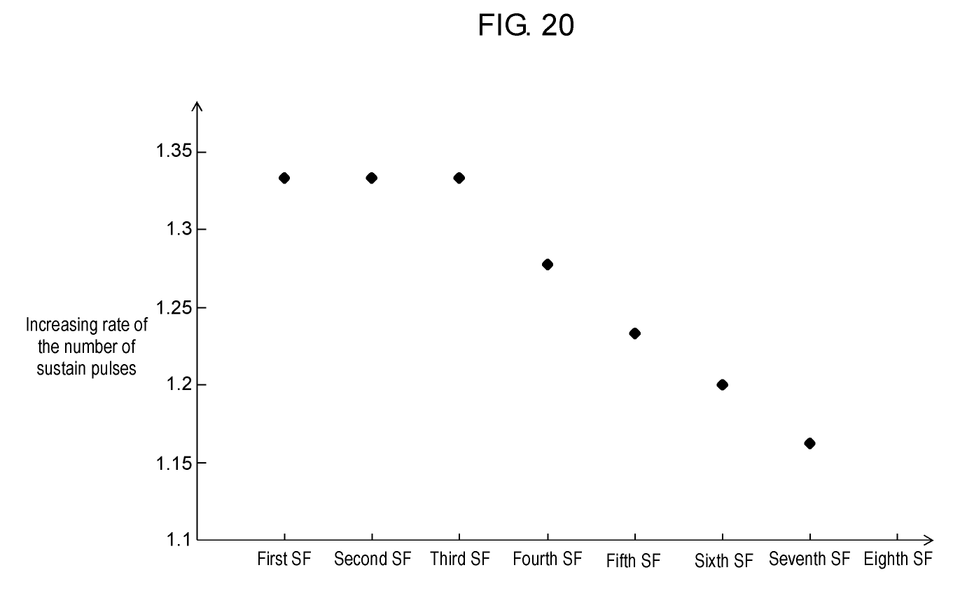

FIG. 20 is a graph showing an increasing rate of the number of sustain pulses after “correction” with respect to that before “correction” in each subfield in accordance with the exemplary embodiment of the present invention. In FIG. 20, the horizontal axis shows each subfield; the vertical axis shows an increasing rate of the number of sustain pulses. That is, the vertical axis shows an increasing rate of the number of sustain pulses after “recorrection” with respect to the number of sustain pulses before “correction”. The larger numerical value shows the higher increasing rate of the number of sustain pulses.

FIG. 20 shows averaged measurement results in display of a plurality of typical images considered to appear frequently in a generally-viewed dynamic image using “second correction, “third correction”, and “fourth correction”. In the subfield structure used to drive panel 10, one field is formed of eight subfields (the first SF, the second SF, . . . , the eighth SF) and the respective subfields have luminance weights of 1, 2, 4, 8, 16, 32, 64, and 128. However, the present invention is not limited to this subfield structure.

As shown in FIG. 20, the increasing rate of the number of sustain pulses after “recorrection” with respect to the number of sustain pulses before “correction” tends to be relatively large in subfields having light luminance weights and tends to decrease gradually as the luminance weight increases. In the example of FIG. 20, the increasing rate is equal to or larger than 1.3 in the first SF, the second SF, and the third SF, is approximately 1.28 in the fourth SF, is approximately 1.23 in the fifth SF, is approximately 1.20 in the sixth SF, and is approximately 1.16 in the seventh SF.

Thus, it is verified that the increasing rate of the number of sustain pulses caused by “recorrection” tends to be large in subfields having relatively light luminance weights. However, as shown in “change 1 in the number of sustain pulses” of FIG. 19, a change in the number of sustain pulses caused by “recorrection” in subfields having light luminance weights is not so large with respect to the total number of sustain pulses in one field. Thus, the effect of the change on the brightness in the display image is relatively small.

However, when the change in the number of sustain pulses caused by “recorrection” is represented by the rate with respect to the number of sustain pulses in the sustain period, as shown in “increasing rate” of FIG. 19, the rate tends to be the larger in subfields having the lighter luminance weights and has the larger effect on the luminance in the subfields. This tends to cause the larger effect on the relation between gradation values and emission luminance in the subfields. As described above, the number of sustain pulses changed by the “correction” in the subfields having light luminance weights is likely to have errors relative to the original calculated values. Such errors can degrade the linearity of gradations.

In contrast, as shown in FIG. 20, the increasing rate of the number of sustain pulses caused by “recorrection” tends to be small in subfields having relatively heavy luminance weights. However, as shown in “change 1 in the number of sustain pulses” of FIG. 19, the number of sustain pulses changed by “recorrection” in subfields having heavy luminance weights tends to be relatively large with respect to the total number of sustain pulses in one field. Thus, the effect of the change on the brightness in the display image is relatively large.

However, when the number of sustain pulses changed by “recorrection” is represented by the rate with respect to the number of sustain pulses in the sustain period, as shown in “increasing rate” of FIG. 19, the rate is relatively small in subfields having heavy luminance weights and has a relatively small effect on the luminance in the subfields. This causes a relatively small effect on the relation between gradation values and emission luminance in the subfields. In the subfields having heavy luminance weights, the “round-off errors” are relatively small. Thus, in the number of sustain pulses changed by the “correction”, the difference between the calculated numerical value and the actual correction value of sustain pulses is relatively small.

Consequently, in this exemplary embodiment, the following corrections are made. No “correction” is made in subfields having light luminance weights where errors are likely to occur relative to original calculated values and the change in the number of sustain pulses has a large effect on the relation between gradation values and emission luminance. A “correction” is made using the calculated correction coefficient without adjustment in subfields having heavy luminance weights where a large number of sustain pulses make errors relative to original calculated values unlikely to occur. In subfields between the above subfields, a “correction” is made, using a correction coefficient adjusted at a rate in response to the magnitude of the luminance weight. That is, a “correction” is made, using an “adjusted correction coefficient” that is obtained by multiplying an adjustment gain set for each subfield in response to the magnitude of the luminance weight by the “first correction coefficient”, and any one of the “second correction coefficient”, the “third correction coefficient” and the “fourth correction coefficient”.

Specifically, when a correction coefficient calculated to make “recorrection” (the “second correction coefficient”, the “third correction coefficient”, or the “fourth correction coefficient”) is set as a “recorrection coefficient”, the “correction” is made using an “adjusted correction coefficient” obtained by the following expression:

Adjusted correction coefficient=Adjustment gain×(First correction coefficient×Recorrection coefficient−1)+1

Thus, in each subfield, the number of sustain pulses after “correction” in this exemplary embodiment is obtained by the following calculation:

(The number of sustain pulses before “correction”)×(Adjustment gain×(First correction coefficient×Recorrection coefficient−1)+1)

The adjustment gain is 0% in the subfields set as those having light luminance weights, and 100% in the subfields set as those having heavy luminance weights. In the subfields set between the subfields having light luminance weights and the subfields having heavy luminance weights, the adjustment gain is set to a magnitude in response to the magnitude of the luminance weight.

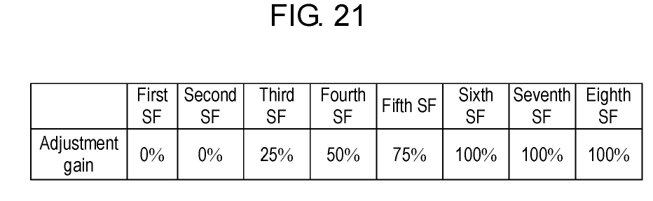

FIG. 21 is a table showing an example of the setting of adjustment gains in accordance with the fifth exemplary embodiment of the present invention. For instance, assume one field is formed of eight subfields, and the first SF through the eighth SF have respective luminance weights of 1, 2, 4, 8, 16, 32, 64, and 128.

In this case, in this exemplary embodiment, the first SF and the second SF are set as subfields having light luminance weights, and the sixth SF, the seventh SF, and the eighth SF are set as subfields having heavy luminance weights. The adjustment gain is 0% in the first SF and the second SF set as subfields having light luminance weights, and is 100% in the sixth SF, the seventh SF, and the eighth SF set as subfields having heavy luminance weights. In the third SF, the fourth SF, and the fifth SF set as subfields between the above subfields, the respective adjustment gains are 25%, 50%, and 75%. In this case, in the first SF and the second SF, the number of sustain pulses after “correction” is equal to the number of sustain pulses before “correction”. In the sixth SF through the eighth SF, the number of sustain pulses after “correction” is equal to the number obtained by multiplying the number of sustain pulses before “correction” by the “first correction coefficient” and the “recorrection coefficient”. In the third SF through the fifth SF, the number of sustain pulses after “correction” changes at a rate in response to the magnitude of the adjustment gain.

Thus, corrections can be made in the following manner. No “correction” is made to subfields having light luminance weights, and a “correction” is made to subfields having heavy luminance weights using the correction coefficients calculated without adjustment. Further, a “correction” is made to subfields between the above subfields, using correction coefficients adjusted at a rate in response to the magnitude of the luminance weight. These corrections can further enhance the linearity of gradations in a black display region in the display image, thereby further enhancing the image display quality.

As described above, in this exemplary embodiment, a “first correction coefficient”, and one of a “second correction coefficient”, a “third correction coefficient” and a “fourth correction coefficient” are adjusted, using an adjustment gain set for each subfield in response to the magnitude of the luminance weight. Further, using “adjusted correction coefficients” obtained by the above adjustment, a “correction” is made to the number of sustain pulses in the subfield. This structure can maintain the linearity of gradations in the display image, and prevent a decrease in the brightness in the display image while suppressing an increase in electric power consumption. Further, this structure can enhance the linearity of gradations in a black display region in the display image, thereby enhancing the image display quality.

In the structure described in this exemplary embodiment, adjustment gain=0% in the first SF and the second SF set as “subfields having light luminance weights”, and adjustment gain=100% in the sixth SF, the seventh SF, and the eighth SF set as “subfields having heavy luminance weights”. In the third SF, the fourth SF, and the fifth SF between the above subfields, the respective adjustment gains are 25%, 50%, and 75%. However, the present invention is not limited to the above structure. Preferably, “subfields having light luminance weights” and “subfields having heavy luminance weights” and the values of the adjustment gains in the intermediate subfields are set optimally in consideration of the characteristics of panel 10, the specifications of plasma display apparatus 1, the subfield structure, or the like, based on visual evaluations of images displayed on panel 10, for example.

The exemplary embodiments of the present invention can also be applied to a method for driving a panel by so-called two-phase driving. In the two-phase driving, scan electrode SC1-scan electrode SCn are divided into a first scan electrode group and a second scan electrode group. Further, each address period is divided into two address periods: a first address period where a scan pulse is applied to each scan electrode belonging to a first scan electrode group; and a second address period where the scan pulse is applied to each scan electrode belonging to a second scan electrode group. Also in this case, the advantages similar to the above can be obtained.

The exemplary embodiments of the present invention are also effective in a panel having an electrode structure where a scan electrode is adjacent to a scan electrode and a sustain electrode is adjacent to a sustain electrode. In this electrode structure, the electrodes are arranged on the front substrate in the following order: . . . , a scan electrode, a scan electrode, a sustain electrode, a sustain electrode, a scan electrode, a scan electrode . . . (the electrode structure being referred to as “ABBA electrode structure”).

Each circuit block shown in the exemplary embodiments of the present invention may be formed as an electric circuit that performs each operation shown in the exemplary embodiments, or formed of a microcomputer, for example, programmed so as to perform the similar operations.

In the examples described in the exemplary embodiments, one pixel is formed of discharge cells of R, G, and B three colors. Also a panel that has pixels, each formed of discharge cells of four or more colors, can use the configuration shown in the exemplary embodiments and offer the similar advantages.

The specific numerical values shown in the exemplary embodiments of the present invention are set based on the characteristics of panel 10 that has a 50-inch screen and 1080 display electrode pairs 24, and only show examples in the exemplary embodiments. The present invention is not limited to these numerical values. Preferably, each numerical value is set optimally for the characteristics of the panel, the specifications of the plasma display apparatus, or the like. Variations are allowed for each numerical value within the range in which the above advantages can be obtained. The number of subfields, the luminance weights of the respective subfields, or the like is not limited to the values shown in the exemplary embodiments of the present invention. The subfield structure may be switched in response to an image signal, for example.

### INDUSTRIAL APPLICABILITY

Even in a large, high-definition panel, the present invention can enhance the image display quality by accurately estimating a change in the emission luminance in each subfield, maintaining the linearity of gradations in the display image, and preventing a decrease in the brightness in the display image. Thus, the present invention is useful as a plasma display apparatus and as a method for driving a panel.

### REFERENCE MARKS IN THE DRAWINGS

1, 2 Plasma display apparatus
10 Panel
21 Front substrate
22 Scan electrode
23 Sustain electrode
24 Display electrode pair
25, 33 Dielectric layer
26Protective layer
31 Rear substrate
32 Data electrode
34 Barrier rib
35 Phosphor layer
41 Image signal processing circuit
42 Data electrode driver circuit
43 Scan electrode driver circuit
44 Sustain electrode driver circuit
45, 60, 70, 91 Timing generation circuit
46 All-cell light-emitting rate detection circuit
47 Partial light-emitting rate detection circuit
48 Average value detection circuit
49 APL detection circuit
50, 80 Sustain pulse generation circuit
51, 81 Power recovery circuit
52, 82 Clamp circuit
53 Initializing waveform generation circuit
54 Scan pulse generation circuit
61, 83, 90, 92 Number-of-sustain-pulses corrector
62 Lookup table
62 After-correction number-of-sustain-pulses setting part (After-first-correction number-of-sustain-pulses setting part)
68 After-first-correction numbers-of-sustain-pulses summation part
69 Before-correction numbers-of-sustain-pulses summation part
71 Second correction coefficient calculator
72 Switch
73 After-second-correction number-of-sustain-pulses setting part
74, 75 Multiplier
76, 77 Total sum calculator
78 Third correction coefficient calculator
79 After-third-correction number-of-sustain-pulses setting part
93 Fourth correction coefficient calculator
94 After-fourth-correction number-of-sustain-pulses setting part
Q11, Q12, Q13, Q14, Q21, Q22, Q23, Q24, Q26, Q27, Q28, Q29, QH1-QHn,
QL1-QLn Switching element
C10, C20, C30 Capacitor
L10, L20 Inductor
D11, D12, D21, D22, D30 Diode

1. A plasma display apparatus comprising:
a plasma display panel having a plurality of discharge cells where a plurality of subfields having a luminance weight is disposed in one field and as many sustain pulses as a number corresponding to the luminance weight are applied in a sustain period of each of the subfields to emit light;
an image signal processing circuit for converting an input image signal into image data representing light emission and no light emission in each discharge cell in each subfield;
a sustain pulse generation circuit for generating the sustain pulses corresponding in number to the luminance weight and applying the sustain pulses to the discharge cells in the sustain period;
an all-cell light-emitting rate detection circuit for detecting a rate of the number of discharge cells to be lit with respect to the number of all discharge cells on an image display surface of the plasma display panel, as an all-cell light-emitting rate in each subfield;
a partial light-emitting rate detection circuit for dividing the image display surface of the plasma display panel into a plurality of regions and detecting a rate of the number of discharge cells to be lit with respect to the number of discharge cells in each of the regions, as a partial light-emitting rate in each subfield; and
a timing generation circuit that generates timing signals for controlling the sustain pulse generation circuit, and includes a number-of-sustain-pulses corrector for controlling the number of sustain pulses to be generated in the sustain pulse generation circuit,
wherein the number-of-sustain-pulses corrector includes a lookup table that has stored a plurality of correction coefficients correlated with the all-cell light-emitting rates and the partial light-emitting rates,
in each subfield, the number-of-sustain-pulses corrector adjusts a first correction coefficient that is read out from the lookup table in response to the all-cell light-emitting rate and the partial light-emitting rate and is set for each subfield, and a recorrection coefficient that is set based on the first correction coefficient, by using an adjustment gain having been preset for each subfield in response to a magnitude of the luminance weight, and
the number-of-sustain-pulses corrector corrects the number of sustain pulses set for each subfield based on the input image signal and the luminance weight, by using the first correction coefficient and the recorrection coefficient that have been adjusted with the adjustment gain.

2. The plasma display apparatus of claim 1, wherein
the adjustment gain is at 0% in the subfields set as those having light luminance weights, and 100% in the subfields set as those having heavy luminance weights, and
in each of the subfields set between the subfields having light luminance weights and the subfields having heavy luminance weights, the adjustment gain is set to a magnitude in response to the magnitude of the luminance weight.

3. The plasma display apparatus of claim 2, wherein the number-of-sustain-pulses corrector sets a second correction coefficient as the recorrection coefficient, and sets the second correction coefficient such that a total numbers of sustain pulses in one field period can be equivalent to each other before a correction and after the correction corrected with the first correction coefficient and the second correction coefficient.

4. The plasma display apparatus of claim 2, wherein the number-of-sustain-pulses corrector sets a third correction coefficient as the recorrection coefficient, and sets the third correction coefficient such that estimated values of electric power consumption in one field period can be equivalent to each other before a correction and after the correction corrected with the first correction coefficient and the third correction coefficient.

5. The plasma display apparatus of claim 2 further comprising:
an APL (Average Picture Level) detection circuit for detecting an average picture level of a display image, wherein
the number-of-sustain-pulses corrector sets a fourth correction coefficient, which is obtained by mixing the second correction coefficient and the third correction coefficient at a rate in response to a detection result in the APL detection circuit, as the recorrection coefficient,
the number-of-sustain-pulses corrector sets the second correction coefficient such that the total numbers of sustain pulses in one field period can be equivalent to each other before a correction and after the correction corrected with the first correction coefficient and the second correction coefficient, and
the number-of-sustain-pulses corrector sets the third correction coefficient such that estimated values of electric power consumption in one field period can be equivalent to each other before a correction and after the correction corrected with the first correction coefficient and the third correction coefficient.

6. The plasma display apparatus of any one of claims 3 through 5, wherein the partial light-emitting rate detection circuit calculates an average value of the partial light-emitting rates in the regions where the partial light-emitting rates exceed a predetermined threshold in each subfield, and the first correction coefficient is read out from the lookup table based on the all-cell light-emitting rate and the average value of the partial light-emitting rates.

7. The plasma display apparatus of claim 6, wherein the partial light-emitting rate detection circuit defines one display electrode pair as the one region and detects the partial light-emitting rate for each display electrode pair.

8. A driving method for a plasma display panel emits light in discharge cells by disposing a plurality of subfields each of which has a luminance weight in one field and applying as many sustain pulses as a number corresponding to the luminance weight to the discharge cells in the sustain period, the driving method comprising:
detecting a rate of the number of discharge cells to be lit with respect to the number of all discharge cells on an image display surface of the plasma display panel, as an all-cell light-emitting rate, in each subfield;
dividing the image display surface of the plasma display panel into a plurality of regions, and detecting a rate of the number of discharge cells to be lit with respect to the number of discharge cells in each of the regions, as a partial light-emitting rate, in each subfield;
setting a first correction coefficient based on the all-cell light-emitting rate and the partial light-emitting rate, and a recorrection coefficient based on the first correction coefficient, in each subfield;
adjusting the first correction coefficient and the recorrection coefficient, by using an adjustment gain having been preset for each subfield in response to a magnitude of the luminance weight; and
correcting the number of sustain pulses set for each subfield based on an input image signal and the luminance weight, by using the first correction coefficient and the recorrection coefficient that have been adjusted with the adjustment gain.
